(19) United States
(12) Patent Application Publication
(10) Pub. No.: US 2024/0059125 A1
(43) Pub. Date: Feb. 22, 2024

(54) AIR CONDITIONER FOR VEHICLE

(71) Applicant: SANDEN CORPORATION, Gunma (JP)

(72) Inventors: Ryo MIYAKOSHI, Gunma (JP); Yoshiki SHIBAOKA, Gunma (JP)

(21) Appl. No.: 18/043,985

(22) PCT Filed: Aug. 26, 2021
(86) PCT No.: PCT/JP2021/031285

§ 371 Date: Mar. 3, 2023

(30) Foreign Application Priority Data
Sep. 24, 2020 (JP) 2020-159962

(51) Int. Cl. B60H 1/00

(52) U.S. Cl. CPC B60H 1/00892; B60H 1/00885

(57) ABSTRACT

A vehicle air-conditioning apparatus according to the present invention includes an air-conditioning refrigerant circuit that circulates a refrigerant to cool an inside of a vehicle, a branching refrigerant circuit that branches from the air-conditioning refrigerant circuit and cools a heat generating device, a branching control valve that is provided in the branching refrigerant circuit and controls a flow of the refrigerant flowing into the branching refrigerant circuit from the air-conditioning refrigerant circuit, and a control unit that controls an operation of the air-conditioning refrigerant circuit and the branching control valve. After transition to an operation of cooling the inside of the vehicle by the air-conditioning refrigerant circuit and cooling the heat generating device by the branching refrigerant circuit in parallel, the control unit opens and closes the branching control valve in accordance with a cooling capacity state of the air-conditioning refrigerant circuit.

### TECHNICAL FIELD

The present invention relates to a vehicle air-conditioning apparatus that air-conditions the inside of a vehicle.

### BACKGROUND ART

As a vehicle air-conditioning apparatus suitable for an electric vehicle (including a so-called hybrid vehicle), a vehicle air-conditioning apparatus including a heat pump type refrigerant circuit is known. The refrigerant circuit is a refrigerant circulation circuit in which a compressor, a radiator (condenser), an expansion valve, and a heat absorber (evaporator) are sequentially connected by a refrigerant pipe. An air-conditioning apparatus including the refrigerant circuit includes an external heat exchanger. The air-conditioning apparatus causes the external heat exchanger to absorb the heat of a refrigerant compressed by the compressor and performs heating by heat radiation of the radiator, and causes the external heat exchanger to radiate heat of the compressed refrigerant, and performs cooling by heat absorption of the heat absorber (see, for example, Patent Literature 1 below).

Furthermore, in the electric vehicle, in order to maintain the performance and safety of a battery, it is necessary to cool the battery that increases its temperature due to self-heating or an increase in ambient temperature to an appropriate temperature. For this reason, in the electric vehicle, a battery refrigerant circuit that cools a battery is provided, and heat is exchanged between a refrigerant circulating in an air conditioning refrigerant circuit and a battery refrigerant (chiller water) to lower the temperature of the chiller water, and thus effectively cooling the battery is effectively cooled (Patent Literature 2 below).

### CITATION LIST

### Patent Literature

Patent Literature 1: JP-A-2014-213765
Patent Literature 2: Japanese Patent No. 5860360

### SUMMARY OF INVENTION

### Problems to be Solved by Invention

In the vehicle air-conditioning apparatus, in the case in which a temperature control target such as a battery other than air conditioning is cooled by the refrigerant of a refrigerant circuit, when a transition is made from an operating mode in which the inside of the vehicle is air-conditioned to an operating mode in which the temperature control target such as the battery needs to be cooled and the refrigerant is also sent to a heat exchanger for the temperature control target, a path of heat exchange through which the refrigerant flows increases. Therefore, immediately after the transition, the capacity (number of revolutions) of a compressor becomes insufficient, and a phenomenon occurs in which the temperature of air blown into the inside of the vehicle temporarily increases.

On the other hand, when a transition is similarly made from an operating mode in which the refrigerant is sent to the heat exchanger for the temperature control target to an operating mode in which the cooling of the inside of the vehicle is required and the refrigerant is sent to the heat absorber, the capacity of the compressor is similarly insufficient immediately after the transition, and the air conditioning in the inside of the vehicle is delayed.

An object of the present invention is to cope with such a problem. That is, an object of the present invention is to eliminate, for example, the discomfort of an occupant due to the degradation of the cooling capacity in a vehicle air-conditioning apparatus when a transition is made to an operating mode in which the heat exchange path of a refrigerant increases.

### Solution to Problems

In order to solve such a problem, the present invention has the following configuration.

A vehicle air-conditioning apparatus includes: an air-conditioning refrigerant circuit that circulates a refrigerant to cool an inside of the vehicle; a branch refrigerant circuit that branches from the air-conditioning refrigerant circuit and cools a heat generating device; a branch control valve that is provided in the branch refrigerant circuit and controls circulation of a refrigerant flowing into the branch refrigerant circuit from the air-conditioning refrigerant circuit; and a control unit that controls an operation of the air-conditioning refrigerant circuit and the branch control valve. In the vehicle air-conditioning apparatus, after transition to an operation of cooling the inside of the vehicle by the air-conditioning refrigerant circuit and cooling the heat generating device by the branch refrigerant circuit in parallel, the control unit controls the branch control valve to be opened and closed according to a cooling capacity state of the air-conditioning refrigerant circuit.

### Effects of Invention

According to the vehicle air-conditioning apparatus of the present invention having such a characteristic, the branch control valve is opened and closed in accordance with the cooling capacity state of the air-conditioning refrigerant circuit at the time of transitioning to the operating mode in which the number of heat exchange paths of the refrigerant increases, and thus it is possible to suppress the degradation of the cooling capacity. As a result, it is possible to eliminate the discomfort of the occupant due to the degradation of the cooling capacity.

### BRIEF DESCRIPTION OF DRAWINGS

FIG. 1 is an illustration showing a system configuration of a vehicle air-conditioning apparatus according to an embodiment of the present invention.

FIG. 2 is an illustration showing a control unit of the vehicle air-conditioning apparatus.

FIG. 3 is a control block diagram related to compressor control in the control unit.

FIG. 4 is another control block diagram related to compressor control in the control unit.

FIG. 5 is another control block diagram related to compressor control in the control unit.

FIG. 6 is an illustration explaining increase control of the number of revolutions of a compressor of the control unit.

FIG. 7 is another illustration explaining increase control of the number of revolutions of the compressor of the control unit.

FIG. 8 is an illustration explaining increase control of the number of revolutions of the compressor of the control unit and the opening/closing control of a branch control valve.

### DESCRIPTION OF EMBODIMENTS

In the following, an embodiment of the present invention will be described with reference to the drawings. In the following description, the same reference numerals in different drawings indicate parts having the same function, and redundant description in the respective drawings is appropriately omitted.

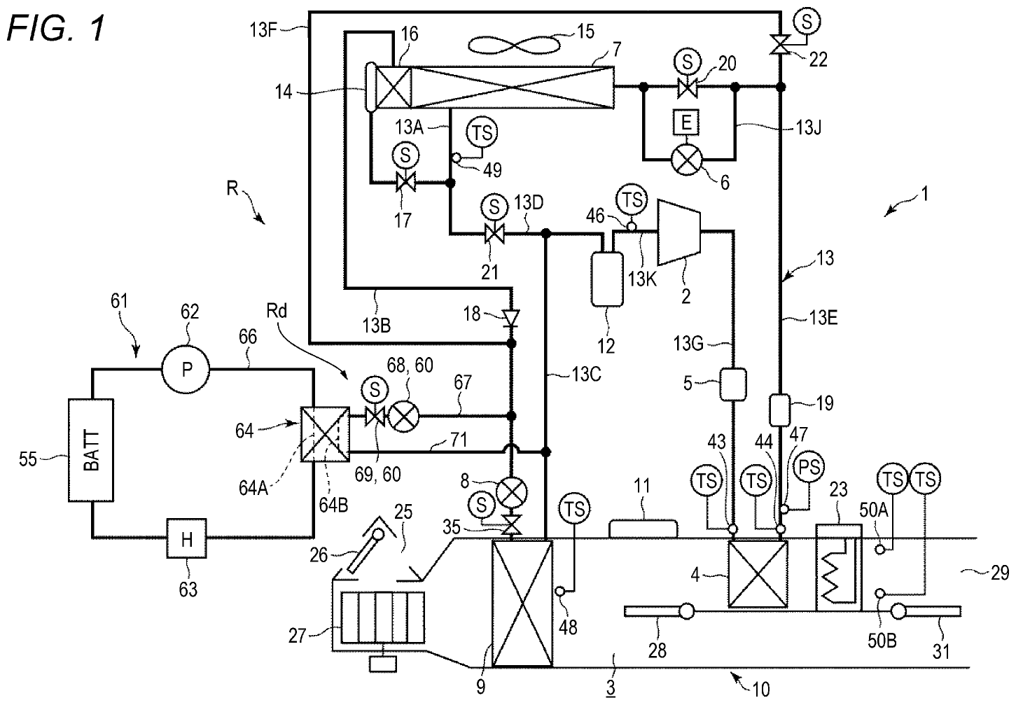

FIG. 1 shows a system configuration of a vehicle air-conditioning apparatus 1 according to an embodiment of the present invention. An example of a vehicle to which an embodiment of the present invention is applied is an electric vehicle (EV) not equipped with an engine (internal combustion engine), which is driven and travels by supplying electric power charged in a battery 55 mounted on the vehicle to a traveling motor (electric motor, not shown), and at that time, a compressor 2, described later, of the vehicle air-conditioning apparatus 1 is also driven by the electric power supplied from the battery 55.

In an electric vehicle that can use no engine waste heat for heating, the vehicle air-conditioning apparatus 1 performs temperature control (cooling) of air conditioning in the inside of the vehicle and a heat generating device such as the battery 55 by switching and executing operating modes of a heating mode, a dehumidifying and heating mode, a dehumidifying and cooling mode, a cooling mode, a defrosting mode, an air conditioning (priority)+battery cooling mode, a battery cooling (priority)+air conditioning mode, and a battery cooling (single) mode by heat pump operation using an air-conditioning refrigerant circuit R.

Note that the embodiment of the present invention is effective not only for an electric vehicle but also for a so-called hybrid vehicle in which an engine and a traveling motor are used. Furthermore, the vehicle to which the shown vehicle air-conditioning apparatus 1 is applied can be charged from an external charger (a quick charger or a normal charger) to the battery 55. Moreover, the battery 55, the traveling motor, an inverter that controls these components, and the like described above are heat generating devices mounted on the vehicle, and these components are temperature control targets. However, in the following description, the battery 55 will be described as an example.

The vehicle air-conditioning apparatus 1 performs air conditioning (heating, cooling, dehumidification, and ventilation) of the inside of an electric vehicle, and includes an electric compressor 2 that compresses a refrigerant, a radiator 4 that is provided in an air flow passage 3 of an HVAC unit 10 through which air in the inside of the vehicle circulates, a high-temperature and high-pressure refrigerant discharged from the compressor 2 flows in through a muffler 5 and a refrigerant pipe 13G, and radiates the heat of the refrigerant (releases heat of the refrigerant) into the inside of the vehicle, an outdoor expansion valve 6 including an electric valve (electronic expansion valve) that decompresses and expands the refrigerant during heating, and an outdoor heat exchanger 7 that functions as a radiator that radiates the heat of the refrigerant during cooling, and performs heat exchange between the refrigerant and outside air to function as an evaporator that absorbs heat of the refrigerant (absorbs heat to the refrigerant) during heating, an indoor expansion valve 8 including a mechanical expansion valve that decompresses and expands the refrigerant, a heat absorber 9 as an evaporator that is provided in the air flow passage 3 and absorbs (evaporates) heat from the inside and outside of the vehicle to the refrigerant during cooling and dehumidification, an accumulator 12, and the like are sequentially connected by a refrigerant pipe 13 to constitute the air-conditioning refrigerant circuit R.

The outdoor expansion valve 6 decompresses and expands the refrigerant that flows out from the radiator 4 and flows into the outdoor heat exchanger 7, and can be fully closed. Furthermore, the indoor expansion valve 8 using a mechanical expansion valve decompresses and expands the refrigerant flowing into the heat absorber 9, and adjusts the degree of superheating of the refrigerant in the heat absorber 9.

Note that the outdoor heat exchanger 7 is provided with an outdoor blower 15. The outdoor blower 15 forcibly ventilates outdoor air to the outdoor heat exchanger 7 to exchange heat between the outdoor air and the refrigerant, and thus the outdoor air is ventilated to the outdoor heat exchanger 7 even while the vehicle is stopped (i.e., the vehicle speed is 0 km/h).

The outdoor heat exchanger 7 sequentially includes a receiver dryer 14 and a supercooling unit 16 on the refrigerant downstream side. A refrigerant pipe 13A on the refrigerant outlet side of the outdoor heat exchanger 7 is connected to the receiver dryer 14 through an electromagnetic valve 17 (for cooling) as an on-off valve opened when the refrigerant flows to the heat absorber 9. A refrigerant pipe 13B on the outlet side of the supercooling unit 16 is connected to the refrigerant inlet side of the heat absorber 9 through a check valve 18, an indoor expansion valve 8, and an electromagnetic valve 35 (for a cabin) as a heat absorber valve device sequentially. Note that the receiver dryer unit 14 and the supercooling unit 16 structurally constitute a part of the outdoor heat exchanger 7. Furthermore, in the check valve 18, the direction of the indoor expansion valve 8 is the forward direction. Moreover, here, the indoor expansion valve 8 and the electromagnetic valve 35 are constituted with an expansion valve with an electromagnetic valve.

Furthermore, the refrigerant pipe 13A out from the outdoor heat exchanger 7 branches into a refrigerant pipe 13D, and the branched refrigerant pipe 13D is connected in communication with to a refrigerant pipe 13C on the refrigerant outlet side of the heat absorber 9 through an electromagnetic valve 21 (for heating) as an on-off valve opened during heating. The refrigerant pipe 13C is connected to the inlet side of the accumulator 12, and the outlet side of the accumulator 12 is connected to a refrigerant pipe 13K on the refrigerant suction side of the compressor 2.

Moreover, a strainer 19 is connected to a refrigerant pipe 13E on the refrigerant outlet side of the radiator 4, and the refrigerant pipe 13E is branched into a refrigerant pipe 13J and a refrigerant pipe 13F on the front side of the outdoor expansion valve 6 (refrigerant upstream side), and one branched refrigerant pipe 13J is connected to the refrigerant inlet side of the outdoor heat exchanger 7 through the outdoor expansion valve 6. Furthermore, the other branched refrigerant pipe 13F is connected in communication with a refrigerant pipe 13B located on the refrigerant downstream side of the check valve 18 and on the refrigerant upstream side of the indoor expansion valve 8 through an electromagnetic valve 22 (for dehumidification) as an on-off valve opened at the time of dehumidification.

As a result, the refrigerant pipe 13F is connected in parallel to the series circuit of the outdoor expansion valve 6, the outdoor heat exchanger 7, and the check valve 18, and becomes a bypass circuit that bypasses the outdoor expansion valve 6, the outdoor heat exchanger 7, and the check valve 18. Furthermore, an electromagnetic valve 20 as an on-off valve for bypass is connected in parallel to the outdoor expansion valve 6.

Furthermore, in the air flow passage 3 on the air upstream side of the heat absorber 9, suction ports of an outside air suction port and an inside air suction port are formed (represented by a suction port 25 in FIG. 1). The suction port 25 is provided with a suction switch damper 26 that switches air to be introduced into the air flow passage 3 between inside air (inside air circulation) that is air inside the cabin and outside air (outside air introduction) that is air outside the cabin. Moreover, an indoor blower (blower fan) 27 that feeds the introduced inside air and outside air to the air flow passage 3 is provided on the air downstream side of the suction switch damper 26.

Note that the suction switch damper 26 here is configured to open and close the outside air suction port and the inside air suction port of the suction port 25 at an arbitrary ratio such that the ratio of the inside air in the air (outside air and inside air) flowing into the heat absorber 9 of the air flow passage 3 can be adjusted to 0 to 100% (the ratio of the outside air can also be adjusted to 100% to 0%).

Furthermore, in the air flow passage 3 on the leeward side (air downstream side) of the radiator 4, an auxiliary heater 23 as an auxiliary heating device including a PTC heater (electric heater) is provided, and the air supplied to the inside of the vehicle through the radiator 4 can be heated. Moreover, in the air flow passage 3 on the air upstream side of the radiator 4, there is provided an air mix damper 28 that adjusts a ratio of air (inside air or outside air) flowing into the air flow passage 3 and passing through the heat absorber 9 in the air flow passage 3 to be ventilated to the radiator 4 and the auxiliary heater 23.

Furthermore, in the air flow passage 3 on the air downstream side of the radiator 4, blow-out ports (represented by blow-out ports 29 in FIG. 1) of a FOOT (foot), a VENT (vent), and a DEF (differential) are formed, and the blow-out port 29 is provided with a blow-out port switch damper 31 that performs switching control of the blow-out of the air from the respective blow-out ports.

The vehicle air-conditioning apparatus 1 includes a branch refrigerant circuit Rd that branches from the air-conditioning refrigerant circuit R and cools a heat generating device (here, the battery 55 is taken as an example).

The branch refrigerant circuit Rd is connected in parallel to the air-conditioning refrigerant circuit R by a branch pipe 67 and a refrigerant pipe 71. One end of the branch pipe 67 is connected to the refrigerant pipe 13B located on the refrigerant downstream side of the connection part between the refrigerant pipe 13F and the refrigerant pipe 13B of the refrigerant circuit R and on the refrigerant upstream side of the indoor expansion valve 8. The branch pipe 67 is sequentially provided with an auxiliary expansion valve 68 including a mechanical expansion valve (e.g., a mechanical superheat control valve) and an electromagnetic valve (for a chiller) 69, and the auxiliary expansion valve 68 and the electromagnetic valve 69 constitute a branch control valve 60. Here, the auxiliary expansion valve 68 decompresses and expands the refrigerant flowing into a refrigerant flow path 64B, described later, of a refrigerant-heat medium heat exchanger 64, and adjusts the degree of superheating of the refrigerant in the refrigerant flow path 64B of the refrigerant-heat medium heat exchanger 64.

The other end of the branch pipe 67 is connected to the refrigerant flow path 64B of the refrigerant-heat medium heat exchanger 64, one end of the refrigerant pipe 71 is connected to the outlet of the refrigerant flow path 64B, and the other end of the refrigerant pipe 71 is connected to the refrigerant pipe 13C on the refrigerant upstream side (the refrigerant upstream side of the accumulator 12) from a junction with the refrigerant pipe 13D.

In the branch refrigerant circuit Rd, when the branch control valve 60 is opened and the refrigerant flows to the branch refrigerant circuit Rd, the heat exchange path of the refrigerant increases, and the cooling of the inside of the vehicle by the air-conditioning refrigerant circuit R and the cooling of the heat generating device by the branch refrigerant circuit Rd are performed in parallel.

In the case in which the electromagnetic valve 69 in the branch control valve 60 is opened, the refrigerant (a part or all of the refrigerant) flowing out of the outdoor heat exchanger 7 flows into the branch pipe 67, is decompressed by the auxiliary expansion valve 68, then flows into the refrigerant flow path 64B of the refrigerant-heat medium heat exchanger 64 through the electromagnetic valve 69, and evaporates there. The refrigerant absorbs heat from a heat medium flowing through a heat medium flow path 64A in the process of flowing through the refrigerant flow path 64B, and then is sucked into the compressor 2 from the refrigerant pipe 13K through the refrigerant pipe 71, the refrigerant pipe 13C, and the accumulator 12.

In the shown example, the temperature control (cooling) of the battery 55, which is a heat generating device, is performed by a heat medium circuit 61 that circulates the heat medium (chiller water). In the heat medium circuit 61, the heat medium pipe 66 is connected to the heat medium flow path 64A of the refrigerant-heat medium heat exchanger 64, and the heat medium passing through the heat medium flow path 64A exchanges heat with the refrigerant flowing through the branch refrigerant circuit Rd. In the shown example, the heat medium circuit 61 includes a circulation pump 62 and a heat medium heater 63.

Examples of the heat medium flowing through the heat medium circuit 1 include water, a refrigerant such as HFO-1234yf, or a liquid such as a coolant, which can be adopted. Here, the heat medium of the heat medium circuit 1 and the refrigerant of the branch refrigerant circuit Rd exchange heat to cool the battery 55, which is a heat generating device. However, the present invention is not limited to this, and the heat generating device may be directly cooled by the refrigerant of the branch refrigerant circuit Rd.

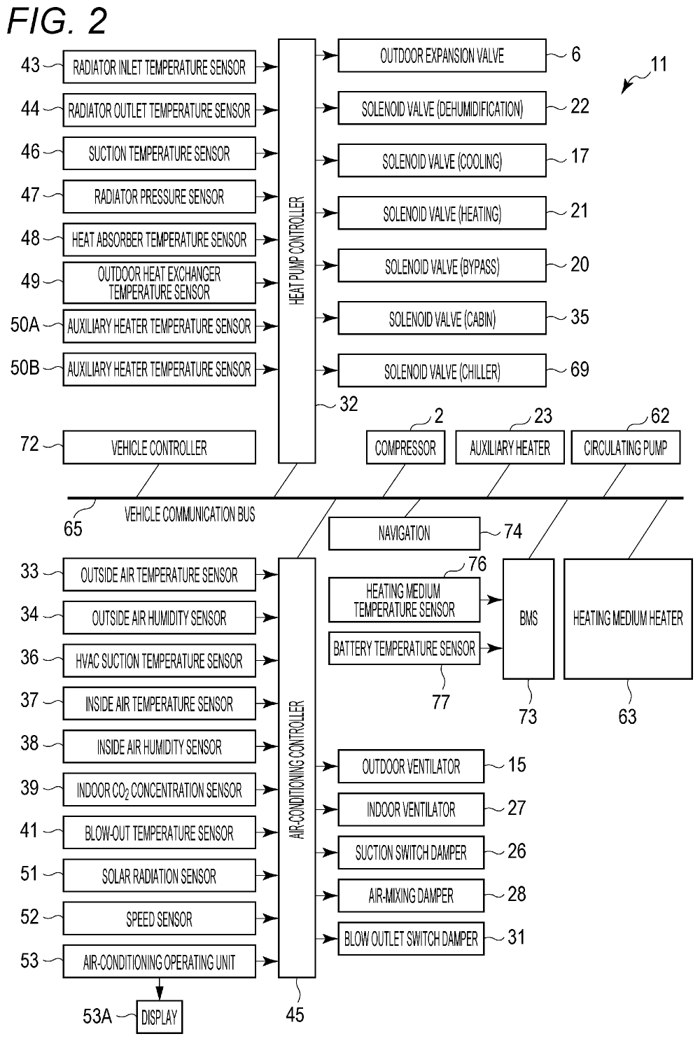

FIG. 2 is a block diagram of the control unit 11 of the vehicle air-conditioning apparatus 1. The control unit 11 includes an air conditioning controller 45 and a heat pump controller 32 both formed of a microcomputer, which is an example of a computer including a processor. The air conditioning controller 45 and the heat pump controller 32 are connected to a vehicle communication bus 65 constituting a controller area network (CAN) or a local interconnect network (LIN). Furthermore, the compressor 2, the auxiliary heater 23, the circulation pump 62, and the heating medium heater 63 are also connected to the vehicle communication bus 65, and the air conditioning controller 45, the heat pump controller 32, the compressor 2, the auxiliary heater 23, the circulation pump 62, and the heating medium heater 63 are configured to transmit and receive data through the vehicle communication bus 65.

Moreover, to the vehicle communication bus 65, a vehicle controller 72 (ECU) that controls the entire vehicle including traveling, a battery controller (BMS: Battery Management system) 73 that controls the charging and discharging of the battery 55, and a GPS navigation device 74 are connected. The vehicle controller 72, the battery controller 73, and the GPS navigation device 74 are also formed of a microcomputer, which is an example of a computer including a processor, and the air-conditioning controller 45 and the heat pump controller 32 constituting the control unit 11 are configured to transmit and receive information (data) to and from the vehicle controller 72, the battery controller 73, and the GPS navigation device 74 through the vehicle communication bus 65.

The air conditioning controller 45 is a host controller that controls air conditioning in the passenger compartment of the vehicle. The inputs of the air conditioning controller 45 are connected to the outputs of an outside air temperature sensor 33 that detects an outside air temperature Tam of the vehicle, an outside air humidity sensor 34 that detects an outside air humidity, an HVAC suction temperature sensor 36 that detects a temperature of air sucked into the air flow passage 3 from the suction port 25 and flowing into the heat absorber 9, an inside air temperature sensor 37 that detects an air (inside air) temperature in the passenger compartment, an inside air humidity sensor 38 that detects a humidity of air in the passenger compartment, an inside CO₂ concentration sensor 39 that detects a concentration of carbon dioxide in the passenger compartment, a blowing-out temperature sensor 41 that detects a temperature of air blown into the passenger compartment, and a photosensor type solar radiation sensor 51, for example, that detects a solar radiation amount into the passenger compartment, and a vehicle speed sensor 52 that detects a moving speed (vehicle speed VSP) of the vehicle and an air-conditioning operating unit 53 that operates air conditioning settings of the inside of the vehicle such as set temperatures and the switching of operating modes and displaying information. The air-conditioning operating unit 53 is provided with a display 53A as a display output device as necessary.

The outputs of the air conditioning controller 45 are connected to the outdoor blower 15, the indoor blower (blower fan) 27, the suction switch damper 26, the air mix damper 28, and the outlet switch damper 31, which are controlled by the air conditioning controller 45.

The heat pump controller 32 mainly controls the operation of the air-conditioning refrigerant circuit R and controls the branch control valve 60 in the branch refrigerant circuit Rd. The inputs of the heat pump controller 32 are connected to a radiator inlet temperature sensor 43 that detects a refrigerant inlet temperature Tcxin of the radiator 4 (which is also a refrigerant temperature discharged from the compressor 2), a radiator outlet temperature sensor 44 that detects a refrigerant outlet temperature Tci of the radiator 4, a suction temperature sensor 46 that detects a suction refrigerant temperature Ts of the compressor 2, a radiator pressure sensor 47 that detects a refrigerant pressure on a refrigerant outlet side of the radiator 4 (pressure of the radiator 4: radiator pressure Pci), a heat absorber temperature sensor 48 that detects a temperature of the heat absorber 9 (refrigerant temperature of the heat absorber 9: heat absorber temperature Te), an outdoor heat exchanger temperature sensor 49 that detects a refrigerant temperature at an outlet of the outdoor heat exchanger 7 (refrigerant evaporation temperature of the outdoor heat exchanger 7: outdoor heat exchanger temperature TXO), and an auxiliary heater temperature sensor 50A (driver's seat side) and an auxiliary heater temperature sensor 50B (passenger's seat side) that detect a temperature of the auxiliary heater 23.

The outputs of heat pump controller 32 are connected to solenoid valves of the solenoid valve 69 (for the chiller) as the outdoor expansion valve 6, the solenoid valve 22 (for dehumidification), the solenoid valve 17 (for cooling), the solenoid valve 21 (for heating), the solenoid valve 20 (for bypass), the solenoid valve 35 (for cabin), and the branch control valve 60, which are controlled by the heat pump controller 32. Note that the compressor 2, the auxiliary heater 23, the circulation pump 62, and the heating medium heater 63 each have a built-in controller. Here, the controllers of the compressor 2, the auxiliary heater 23, the circulation pump 62, and the heating medium heater 63 transmit and receive data to and from the heat pump controller 32 through the vehicle communication bus 65, and are controlled by the heat pump controller 32.

Note that the circulation pump 62 and the heating medium heater 63 of the heating medium circuit 61 may be controlled by the battery controller 73. Furthermore, the battery controller 73 is connected to the outputs of a heat medium temperature sensor 76 that detects a temperature (heat medium temperature Tw) of the heat medium on the outlet side of the heat medium flow path 64A of the refrigerant-heat medium heat exchanger 64 of the heat medium circuit 61 and a battery temperature sensor 77 that detects a temperature of the battery 55 (temperature of the battery 55 itself: battery temperature Tcell). Here, the remaining capacity (state of charge) of the battery 55, information on the charge of the battery 55 (information indicating that charging is in progress, charging completion time, remaining charging time, and the like), the heat medium temperature Tw, the battery temperature Tcell, the heating value of the battery 55 (calculated by the battery controller 73 from the power supply amount and the like), and the like are transmitted from the battery controller 73 to the heat pump controller 32, the air conditioning controller 45, and the vehicle controller 72 through the vehicle communication bus 65. The information on the charge completion time and the remaining charge time at the time of charging the battery 55 is information supplied from an external charger such as a quick charger. Furthermore, output Mpower of the traveling motor is transmitted from the vehicle controller 72 to the heat pump controller 32 and the air conditioning controller 45.

The heat pump controller 32 and the air conditioning controller 45 mutually transmit and receive data through the vehicle communication bus 65, and control each device based on the output of each sensor and the setting input by the air-conditioning operating unit 53. Here, the outside air temperature sensor 33, the outside air humidity sensor 34, the HVAC suction temperature sensor 36, the inside air temperature sensor 37, the inside air humidity sensor 38, the indoor CO₂ concentration sensor 39, a blowout temperature sensor 41, the solar radiation sensor 51, the vehicle speed sensor 52, an air volume Ga of air flowing into the air flow passage 3 and flowing through the air flow passage 3 (calculated by the air conditioning controller 45), an air volume ratio SW by the air mix damper 28 (calculated by the air conditioning controller 45), a voltage of the indoor air blower 27 (BLV), information from the battery controller 73 described above, information from the GPS navigation device 74, and the output of the air-conditioning operating unit 53 are transmitted from the air-conditioning controller 45 to the heat pump controller 32 through the vehicle communication bus 65, and are used for control by the heat pump controller 32.

Furthermore, the heat pump controller 32 also transmits data (information) related to control of the air-conditioning refrigerant circuit R and the like to the air-conditioning controller 45 through the vehicle communication bus 65. Note that the air volume ratio SW by the air mix damper 28 described above is calculated by the air-conditioning controller 45 in the range of 0≤SW≤1. When SW=1, all the air passing through the heat absorber 9 is ventilated to the radiator 4 and the auxiliary heater 23 by the air mix damper 28.

An operation example of the vehicle air-conditioning apparatus 1 will be described with the above configuration. Here, the control unit 11 (the air-conditioning controller 45, the heat pump controller 32, and the battery controller 73) switches between and executes the air conditioning operation in the heating mode, the dehumidifying and heating mode, the dehumidifying and cooling mode, the cooling mode, and the air conditioning (priority)+battery cooling mode, the battery cooling operation in the battery cooling (priority)+air conditioning mode, and the battery cooling (single) mode, and the defrosting mode.

The air conditioning operations in the heating mode, the dehumidifying and heating mode, the dehumidifying and cooling mode, the cooling mode, and the air conditioning (priority)+battery cooling mode are performed when the battery 55 is not charged, the ignition (IGN) of the vehicle is turned on, and the air conditioning switch of the air-conditioning operating unit 53 is turned on. However, during remote operation (pre-air-conditioning or the like), the operation is also executed even though the ignition is OFF. Furthermore, the air conditioning operations are executed when no battery cooling request is made and the air conditioning switch is turned on even during the charging of the battery 55. On the other hand, the battery cooling operation in the battery cooling (priority)+air conditioning mode and the battery cooling (single) mode is executed, for example, when the plug of a quick charger (external power supply) is connected and the battery 55 is charged. However, the battery cooling (single) mode is executed when the air-conditioning switch is turned off and a battery cooling request is made (for example, when the vehicle is running at high outside temperature) in addition to when the battery 55 is being charged.

Furthermore, here, when the ignition is turned on or the battery 55 is being charged even though the ignition is turned off, the heat pump controller 32 operates the circulation pump 62 of the heat medium circuit 61 to circulate the heat medium in the heat medium pipe 66.

(1) Heating Mode

First, the heating mode will be described. The control of each device is executed by the control unit 11 (cooperation of the heat pump controller 32 and the air conditioning controller 45). However, in the following description, the heat pump controller 32 will be a control main body and will be described in a simplified manner. When the heating mode is selected by the heat pump controller 32 (auto mode) or by a manual air conditioning setting operation (manual mode) to the air-conditioning operating part 53 of the air conditioning controller 45, the heat pump controller 32 opens the electromagnetic valve 21 and closes the electromagnetic valve 17, the electromagnetic valve 20, the electromagnetic valve 22, the electromagnetic valve 35, and the electromagnetic valve 69. The compressor 2 and the blowers 15 and 27 are then operated, and the air mix damper 28 is turned into the state of adjusting the ratio of the air blown out from the indoor blower 27 to be ventilated to the radiator 4 and the auxiliary heater 23.

As a result, the high-temperature and high-pressure gas refrigerant discharged from the compressor 2 flows into the radiator 4. Since the air in the air flow passage 3 is ventilated to the radiator 4, the air in the air flow passage 3 exchanges heat with the high-temperature refrigerant in the radiator 4 for heating. On the other hand, the refrigerant in the radiator 4 is cooled by being deprived of heat by the air, and is condensed and liquefied.

The refrigerant liquefied in the radiator 4 flows out from the radiator 4, and then reaches the outdoor expansion valve 6 through the refrigerant pipes 13E and 13J. The refrigerant flowing into the outdoor expansion valve 6 is decompressed there, and then flows into the outdoor heat exchanger 7. The refrigerant that flows into the outdoor heat exchanger 7 evaporates, and pumps up heat (absorbs heat) by traveling or from outside air ventilated by the outdoor blower 15. The low-temperature refrigerant that flows out from the outdoor heat exchanger 7 repeats circulation in which the refrigerant then reaches the refrigerant pipe 13C through the refrigerant pipe 13A, the refrigerant pipe 13D, and the electromagnetic valve 21, further enters the accumulator 12 through the refrigerant pipe 13C, and after being separated into gas and liquid, the gas refrigerant is sucked into the compressor 2 from the refrigerant pipe 13K. The air heated by the radiator 4 is blown out from the blow-out port 29, and thus the inside of the vehicle is heated.

The heat pump controller 32 calculates a target radiator pressure PCO from a target heater temperature TCO (target temperature of the radiator 4) calculated from a target blown air temperature TAO, described later, which is a target temperature of air blown into the inside of the vehicle (target value of temperature of air blown into the inside of the vehicle), controls the number of revolutions of the compressor 2 based on the target radiator pressure PCO and a radiator pressure Pci (high pressure of the refrigerant circuit R) detected by the radiator pressure sensor 47, controls the valve opening of the outdoor expansion valve 6 based on a refrigerant outlet temperature Tci of the radiator 4 detected by the radiator outlet temperature sensor 44 and the radiator pressure Pci detected by the radiator pressure sensor 47, and controls the supercooling degree of the refrigerant at the outlet of the radiator 4.

Furthermore, in the case in which the heating capacity (heating capacity) of the radiator 4 is insufficient with respect to the required heating capacity, the heat pump controller 32 supplements the insufficient heating capacity with heat generated by the auxiliary heater 23. As a result, the inside of the vehicle is heated without any trouble even at a low outside air temperature or the like.

(2) Dehumidifying and Heating Mode

Next, the dehumidifying and heating mode will be described. In the dehumidifying and heating mode, the heat pump controller 32 opens the solenoid valve 21, the solenoid valve 22, and the solenoid valve 35, and closes the solenoid valve 17, the solenoid valve 20, and the solenoid valve 69. The compressor 2 and the blowers 15 and 27 are then operated, and the air mix damper 28 is turned into the state of adjusting the ratio of the air blown out from the indoor blower 27 to be ventilated to the radiator 4 and the auxiliary heater 23.

As a result, the high-temperature and high-pressure gas refrigerant discharged from the compressor 2 flows into the radiator 4. Since the air in the air flow passage 3 is ventilated to the radiator 4, the air in the air flow passage 3 exchanges heat with the high-temperature refrigerant in the radiator 4 for heating. On the other hand, the refrigerant in the radiator 4 is cooled by being deprived of heat by the air, and is condensed and liquefied.

The refrigerant liquefied in the radiator 4 flows out from the radiator 4, and then partially enters the refrigerant pipe 13J through the refrigerant pipe 13E to reach the outdoor expansion valve 6. The refrigerant flowing into the outdoor expansion valve 6 is decompressed there, and then flows into the outdoor heat exchanger 7. The refrigerant that flows into the outdoor heat exchanger 7 evaporates, and pumps up heat (absorbs heat) by traveling or from outside air ventilated by the outdoor blower 15. The low-temperature refrigerant that flows out from the outdoor heat exchanger 7 repeats circulation in which the refrigerant then reaches the refrigerant pipe 13C through the refrigerant pipe 13A, the refrigerant pipe 13D, and the electromagnetic valve 21, enters the accumulator 12 through the refrigerant pipe 13C, and after being separated into gas and liquid there, the gas refrigerant is sucked into the compressor 2 from the refrigerant pipe 13K.

On the other hand, the remaining condensed refrigerant flowing through the refrigerant pipe 13E through the radiator 4 is divided, and the divided refrigerant flows into the refrigerant pipe 13F through the electromagnetic valve 22 and reaches the refrigerant pipe 13B. Subsequently, the refrigerant reaches the indoor expansion valve 8, is decompressed by the indoor expansion valve 8, then flows into the heat absorber 9 through the electromagnetic valve 35, and evaporates. At this time, moisture in the air blown out from the indoor blower 27 condenses and adheres to the heat absorber 9 by the heat absorbing action of the refrigerant generated in the heat absorber 9, and thus the air is cooled and dehumidified.

The refrigerant evaporated at the heat absorber 9 repeats circulation in which the refrigerant flows out to the refrigerant pipe 13C, joins the refrigerant from the refrigerant pipe 13D (the refrigerant from the outdoor heat exchanger 7), then passes through the accumulator 12, and sucked into the compressor 2 from the refrigerant pipe 13K. The air dehumidified by the heat absorber 9 is reheated in the process of passing through the radiator 4 and the auxiliary heater 23 (when heat is generated), and thus the dehumidification and heating of the inside of the vehicle are performed.

Here, the heat pump controller 32 controls the number of rotations of the compressor 2 based on the target radiator pressure PCO calculated from the target heater temperature TCO and the radiator pressure Pci (high pressure of the refrigerant circuit R) detected by the radiator pressure sensor 47, or controls the number of rotations of the compressor 2 based on the temperature of the heat absorber 9 (heat absorber temperature Te) detected by the heat absorber temperature sensor 48 and a target heat absorber temperature TEO that is its target value. At this time, the heat pump controller 32 selects one of the radiator pressure Pci and the heat absorber temperature Te, which is lower in the target number of revolutions of the compressor obtained from either calculation (lower one of TGNCh and TGNCc, described later) to control the compressor 2. Furthermore, the valve opening degree of the outdoor expansion valve 6 is controlled based on the heat absorber temperature Te.

Furthermore, in the case in which the heating capability (heating capability) of the radiator 4 is insufficient with respect to the heating capability necessary in the dehumidifying and heating mode as well, the heat pump controller 32 supplements the insufficient heating capability with heat generated by the auxiliary heater 23. Accordingly, the inside of the vehicle is dehumidified and heated without any trouble even at a low outside air temperature or the like.

(3) Dehumidifying Cooling Mode

Next, the dehumidifying cooling mode will be described. In the dehumidifying cooling mode, the heat pump controller 32 opens the electromagnetic valve 17 and the electromagnetic valve 35, and closes the electromagnetic valve 20, the electromagnetic valve 21, the electromagnetic valve 22, and the electromagnetic valve 69. The compressor 2 and the blowers 15 and 27 are then operated, and the air mix damper 28 is turned into the state of adjusting the ratio of the air blown out from the indoor blower 27 to be ventilated to the radiator 4 and the auxiliary heater 23.

As a result, the high-temperature and high-pressure gas refrigerant discharged from the compressor 2 flows into the radiator 4. Since the air in the air flow passage 3 is ventilated to the radiator 4, the air in the air flow passage 3 exchanges heat with the high-temperature refrigerant in the radiator 4 for heating. On the other hand, the refrigerant in the radiator 4 is deprived of heat by the air, cooled, and condensed and liquefied.

The refrigerant that flows out from the radiator 4 reaches the outdoor expansion valve 6 through the refrigerant pipes 13E and 13J, and flows into the outdoor heat exchanger 7 through the outdoor expansion valve 6 that is controlled to be slightly opened (a region with a larger valve opening degree) than in the heating mode or the dehumidifying and heating mode. The refrigerant that flows into the outdoor heat exchanger 7 is air-cooled and condensed by traveling or by outside air ventilated by the outdoor blower 15. The refrigerant that flows out from the outdoor heat exchanger 7 enters the refrigerant pipe 13B through the refrigerant pipe 13A, the electromagnetic valve 17, the receiver dryer unit 14, and the supercooling unit 16, and reaches the indoor expansion valve 8 through the check valve 18. After the refrigerant is decompressed by the indoor expansion valve 8, the refrigerant flows into the heat absorber 9 through the electromagnetic valve 35 and evaporates. By the heat absorbing action at this time, moisture in the air blown out from the indoor blower 27 condenses and adheres to the heat absorber 9, and the air is cooled and dehumidified.

The refrigerant evaporated in heat absorber 9 repeats circulation in which the refrigerant reaches the accumulator 12 through the refrigerant pipe 13C, and is sucked into the compressor 2 through the refrigerant pipe 13K. The air cooled and dehumidified by the heat absorber 9 is reheated (heating capability is lower than that in dehumidifying and heating) in the process of passing through the radiator 4 and the auxiliary heater 23 (when heat is generated), and thus the dehumidifying and cooling of the inside of the vehicle is performed.

The heat pump controller 32 controls the number of revolutions of the compressor 2 such that the heat absorber temperature Te becomes the target heat absorber temperature TEO based on the temperature (heat absorber temperature Te) of the heat absorber 9 detected by the heat absorber temperature sensor 48 and the target heat absorber temperature TEO that is the target temperature (target value of the heat absorber temperature Te) of the heat absorber 9, and controls the valve opening degree of the outdoor expansion valve 6 such that the radiator pressure Pci becomes the target radiator pressure PCO based on the radiator pressure Pci (high pressure of the refrigerant circuit R) detected by the radiator pressure sensor 47 and the target radiator pressure PCO (target value of the radiator pressure Pci), and thus a necessary heat amount (reheating amount) is obtained by the radiator 4.

Furthermore, in the case in which the heating capability (reheating capability) of the radiator 4 is insufficient with respect to the heating capability necessary in the dehumidifying and cooling mode as well, the heat pump controller 32 supplements the insufficient heating capability with heat generated by the auxiliary heater 23. Accordingly, dehumidifying and cooling are performed without excessively lowering the temperature in the inside of the vehicle.

(4) Cooling Mode (Air Conditioning (Single) Mode)

Next, the cooling mode will be described. In the cooling mode, the heat pump controller 32 opens the solenoid valve 17, the solenoid valve 20, and the solenoid valve 35, and closes the solenoid valve 21, the solenoid valve 22, and the solenoid valve 69. The compressor 2 and the blowers 15 and 27 are then operated, and the air mix damper 28 is turned into the state of adjusting the ratio of the air blown out from the indoor blower 27 to be ventilated to the radiator 4 and the auxiliary heater 23. Note that the auxiliary heater 23 is not energized.

As a result, the high-temperature and high-pressure gas refrigerant discharged from the compressor 2 flows into the radiator 4. Although the air in the air flow passage 3 is ventilated to the radiator 4, the ratio of the air is small (only for reheating during cooling), and thus the refrigerant mostly passes through the radiator 4, and the refrigerant that flows out from the radiator 4 reaches the refrigerant pipe 13J through the refrigerant pipe 13E. At this time, since the electromagnetic valve 20 is opened, the refrigerant passes through the electromagnetic valve 20 and flows into the outdoor heat exchanger 7 as it is, and is air-cooled by traveling or by outside air ventilated by the outdoor blower 15, and is condensed and liquefied.

The refrigerant that flows out from the outdoor heat exchanger 7 enters the refrigerant pipe 13B through the refrigerant pipe 13A, the electromagnetic valve 17, the receiver dryer unit 14, and the supercooling unit 16, and reaches the indoor expansion valve 8 through the check valve 18. After the refrigerant is decompressed by the indoor expansion valve 8, the refrigerant flows into the heat absorber 9 through the electromagnetic valve 35 and evaporates. The heat absorbing action at this time cools the air blown out of the indoor blower 27, and the air is heat-exchanged with the heat absorber 9.

The refrigerant evaporated in heat absorber 9 repeats circulation in which the refrigerant reaches the accumulator 12 through the refrigerant pipe 13C, and is sucked into the compressor 2 through the refrigerant pipe 13K. The air cooled by the heat absorber 9 is blown into the inside of the vehicle from the blow-out port 29, and thus the inside of the vehicle is cooled. In this cooling mode, the heat pump controller 32 controls the number of rotations of the compressor 2 based on the temperature (heat absorber temperature Te) of the heat absorber 9 detected by the heat absorber temperature sensor 48.

(5) Air Conditioning (Priority)+Battery Cooling Mode (Air Conditioning (Priority)+Temperature Control Target Cooling Mode)

Next, the air conditioning (priority)+battery cooling mode will be described. In the air conditioning (priority)+battery cooling mode, the heat pump controller 32 opens the electromagnetic valve 17, the electromagnetic valve 20, the electromagnetic valve 35, and the electromagnetic valve 69, and closes the electromagnetic valve 21 and the electromagnetic valve 22.

The compressor 2 and the blowers 15 and 27 are then operated, and the air mix damper 28 is turned into the state of adjusting the ratio of the air blown out from the indoor blower 27 to be ventilated to the radiator 4 and the auxiliary heater 23. Note that in this operating mode, the auxiliary heater 23 is not energized. Furthermore, the heating medium heater 63 is not energized as well.

As a result, the high-temperature and high-pressure gas refrigerant discharged from the compressor 2 flows into the radiator 4. Although the air in the air flow passage 3 is ventilated to the radiator 4, the ratio of the air is small (only for reheating during cooling), and thus the refrigerant mostly passes through the radiator 4, and the refrigerant that flows out from the radiator 4 reaches the refrigerant pipe 13J through the refrigerant pipe 13E. At this time, since the electromagnetic valve 20 is opened, the refrigerant passes through the electromagnetic valve 20 and flows into the outdoor heat exchanger 7 as it is, and is air-cooled by traveling or by outside air ventilated by the outdoor blower 15, and is condensed and liquefied.

The refrigerant that flows out from the outdoor heat exchanger 7 enters the refrigerant pipe 13B through the refrigerant pipe 13A, the electromagnetic valve 17, the receiver dryer unit 14, and the supercooling unit 16. The refrigerant that flows into the refrigerant pipe 13B is divided after passing through the check valve 18, and one of the refrigerant flows directly through the refrigerant pipe 13B to reach the indoor expansion valve 8. The refrigerant that flows into the indoor expansion valve 8 is decompressed there, then flows into the heat absorber 9 through the electromagnetic valve 35, and evaporates. The heat absorbing action at this time cools the air blown out of the indoor blower 27, and the air is heat-exchanged with the heat absorber 9.

The refrigerant evaporated in heat absorber 9 repeats circulation in which the refrigerant reaches the accumulator 12 through the refrigerant pipe 13C, and is sucked into the compressor 2 through the refrigerant pipe 13K. The air cooled by the heat absorber 9 is blown into the inside of the vehicle from the blow-out port 29, and thus the inside of the vehicle is cooled.

On the other hand, the rest of the refrigerant passing through the check valve 18 is diverted, flows into the branch pipe 67, and reaches the auxiliary expansion valve 68. Here, after being decompressed, the refrigerant flows into the refrigerant flow path 64B of the refrigerant-heat medium heat exchanger 64 through the electromagnetic valve 69, and evaporates there. At this time, the heat absorbing action is exhibited. The refrigerant evaporated in the refrigerant flow path 64B repeats circulation in which the refrigerant passes through the refrigerant pipe 71, the refrigerant pipe 13C, and the accumulator 12, and is sucked from the refrigerant pipe 13K into the compressor 2.

On the other hand, since the circulation pump 62 is operated, the heat medium discharged from the circulation pump 62 reaches a heat medium flow path 64A of the refrigerant-heat medium heat exchanger 64 in the heat medium pipe 66, exchanges heat with the refrigerant evaporated in the refrigerant flow path 64B, and heat is absorbed to cool the heat medium. The heat medium flowing out from the heat medium flow path 64A of the refrigerant-heat medium heat exchanger 64 reaches the heat medium heater 63. However, since the heating medium heater 63 does not generate heat in this operating mode, the heating medium directly passes and reaches the battery 55, and exchanges heat with the battery 55. As a result, the battery 55 is cooled, and the heat medium after cooling the battery 55 repeats circulation in which the heat medium is sucked into the circulation pump 62.

In the air conditioning (priority)+battery cooling mode, the heat pump controller 32 maintains the electromagnetic valve 35 in the open state, and controls the number of revolutions of the compressor 2 as described later based on the temperature (heat absorber temperature Te) of the heat absorber 9 detected by the heat absorber temperature sensor 48. Furthermore, here, the electromagnetic valve 69 is controlled to open and close as follows based on the temperature of the heating medium (heating medium temperature Tw, which is transmitted from the battery controller 73) detected by the heating medium temperature sensor 76. Note that the heat medium temperature Tw is adopted as an index indicating the temperature of the battery 55, which is a temperature control target.

That is, the heat pump controller 32 sets an upper limit value TUL and a lower limit value TLL with a predetermined temperature difference above and below a predetermined target heat medium temperature TWO as a target value of the heat medium temperature Tw. In the case in which the heat medium temperature Tw increases from a state in which the electromagnetic valve 69 is closed due to heat generation of the battery 55 or the like and rises to the upper limit value TUL, the electromagnetic valve 69 is opened. As a result, the refrigerant flows into the refrigerant flow path 64B of the refrigerant-heat medium heat exchanger 64 and evaporates, and cools the heat medium flowing through the heat medium flow path 64A, and thus the battery 55 is cooled by the cooled heat medium.

After that, in the case in which the heat medium temperature Tw decreases to the lower limit value TLL, the electromagnetic valve 69 is closed. After that, such opening and closing of the electromagnetic valve 69 is repeated to control the heat medium temperature Tw to the target heat medium temperature TWO while prioritizing the cooling of the inside of the vehicle for cooling the battery 55.

(6) Switching of Air-Conditioning Operation

The heat pump controller 32 calculates the target blown air temperature TAO from the following formula (I). The target blown air temperature TAO is a target value of the temperature of the air blown into the inside of the vehicle from the outlet 29.

TAO=(Tset−Tin)×K+Tbal(f(Tset,SUN,Tam)) (I)

Here, Tset is a set temperature in the inside of the vehicle set by the air-conditioning operating unit 53, Tin is a temperature of air in the inside of the vehicle detected by the inside air temperature sensor 37, K is a coefficient, and Tbal is a balance value calculated from the set temperature Tset, the solar radiation amount SUN detected by the solar radiation sensor 51, and the outside air temperature Tam detected by the outside air temperature sensor 33. In general, the target blown air temperature TAO is higher as the outside air temperature Tam is lower, and decreases as the outside air temperature Tam increases.

At startup, the heat pump controller 32 selects one of the air-conditioning operations based on the outside air temperature Tam detected by the outside air temperature sensor 33 and the target blown air temperature TAO. After the startup, the air conditioning operation is selected and switched according to the operating conditions such as the outside air temperature Tam, the target blown air temperature TAO, the heating medium temperature Tw, and the battery temperature Tcell, the environmental conditions, a change in the setting conditions, and a battery cooling request (mode transition request) from the battery controller 73.

(7) Battery Cooling (Priority)+Air Conditioning Mode (Temperature Control Target Cooling (Priority)+Air Conditioning Mode)

Next, an operation during the charging of the battery 55 will be described. For example, during the charging of the battery 55 with the charging plug of a quick charger (external power supply) connected (these pieces of information are transmitted from the battery controller 73), when a battery cooling request is made regardless of ON/OFF of an ignition (IGN) of the vehicle and an air conditioning switch of the air-conditioning operating unit 53 is turned ON, the heat pump controller 32 executes a battery cooling (priority)+air conditioning mode

However, in the case of the battery cooling (priority)+air conditioning mode, here, the heat pump controller 32 maintains the electromagnetic valve 69 in the open state, and controls the number of revolutions of the compressor 2 as described later based on the heat medium temperature Tw detected by the heat medium temperature sensor 76 (transmitted from the battery controller 73). Furthermore here, the electromagnetic valve 35 is controlled to be opened and closed as follows based on the temperature (heat absorber temperature Te) of the heat absorber 9 detected by the heat absorber temperature sensor 48.

That is, the heat pump controller 32 sets an upper limit value TeUL and a lower limit value TeLL with a predetermined temperature difference above and below a predetermined target heat absorber temperature TEO as a target value of the heat absorber temperature Te. In the case in which the heat absorber temperature Te increases from the state in which the electromagnetic valve 35 is closed to the upper limit value TeUL, the electromagnetic valve 35 is opened. As a result, the refrigerant flows into the heat absorber 9 and evaporates to cool the air flowing through the air flow passage 3.

After that, in the case in which the heat absorber temperature Te decreases to the lower limit value TeLL, the electromagnetic valve 35 is closed. After that, such opening and closing of the electromagnetic valve 35 is repeated to control the heat absorber temperature Te to the target heat absorber temperature TEO while prioritizing the cooling of the battery 55 for cooling the inside of the vehicle.

(8) Battery Cooling (Single) Mode (Temperature Control Target Cooling (Single) Mode)

Subsequently, during the charging of the battery 55 with the charging plug of the quick charger connected in a state in which the air conditioning switch of the air-conditioning operating unit 53 is turned off regardless of ON/OFF of the ignition, in the case in which a battery cooling request is made, the heat pump controller 32 executes a battery cooling (single) mode. However, in addition to during the charging of the battery 55, in the case in which the air conditioning switch is turned off and a battery cooling request is made (for example, when the vehicle is running at a high outside temperature), the operation is performed. In the battery cooling (single) mode, the heat pump controller 32 opens the solenoid valve 17, the solenoid valve 20, and the solenoid valve 69, and closes the solenoid valve 21, the solenoid valve 22, and the solenoid valve 35.

The compressor 2 and the outdoor blower 15 are then operated. Note that the indoor blower 27 is not operated, and the auxiliary heater 23 is not energized as well. Furthermore, in this operating mode, the heating medium heater 63 is also not energized.

As a result, the high-temperature and high-pressure gas refrigerant discharged from the compressor 2 flows into the radiator 4. Since the air in the air flow passage 3 is not ventilated to the radiator 4, the air only passes through the radiator 4, and the refrigerant that flows out from the radiator 4 reaches the refrigerant pipe 13J through the refrigerant pipe 13E. At this time, since the electromagnetic valve 20 is opened, the refrigerant passes through the electromagnetic valve 20, flows into the outdoor heat exchanger 7 as it is, is air-cooled by the outside air ventilated by the outdoor blower 15, and is condensed and liquefied.

The refrigerant that flows out from the outdoor heat exchanger 7 enters the refrigerant pipe 13B through the refrigerant pipe 13A, the electromagnetic valve 17, the receiver dryer unit 14, and the supercooling unit 16. After flowing into the refrigerant pipe 13B, the refrigerant entirely flows into the branch pipe 67 and reaches the auxiliary expansion valve 68 through the check valve 18. Here, after being decompressed, the refrigerant flows into the refrigerant flow path 64B of the refrigerant-heat medium heat exchanger 64 through the electromagnetic valve 69, and evaporates there. At this time, the heat absorbing action is exhibited. The refrigerant evaporated in the refrigerant flow path 64B repeats circulation in which the refrigerant passes through the refrigerant pipe 71, the refrigerant pipe 13C, and the accumulator 12, and is sucked from the refrigerant pipe 13K into the compressor 2.

On the other hand, since the circulation pump 62 is operated, the heat medium discharged from the circulation pump 62 reaches the heat medium flow path 64A of the refrigerant-heat medium heat exchanger 64 in the heat medium pipe 66, and heat is absorbed by the refrigerant evaporating in the refrigerant flow path 64B, and the heat medium is cooled. The heat medium flowing out from the heat medium flow path 64A of the refrigerant-heat medium heat exchanger 64 reaches the heat medium heater 63. However, since the heating medium heater 63 does not generate heat in this operating mode, the heating medium directly passes and reaches the battery 55, and exchanges heat with the battery 55. As a result, the battery 55 is cooled, and the heat medium after cooling the battery 55 repeats circulation in which the heat medium is sucked into the circulation pump 62.

Also in the battery cooling (single) mode, the heat pump controller 32 cools the battery 55 by controlling the number of revolutions of the compressor 2 as described later based on the heat medium temperature Tw detected by the heat medium temperature sensor 76.

(9) Defrosting Mode

Next, the defrosting mode of the outdoor heat exchanger 7 will be described. As described above, in the heating mode, the refrigerant evaporates in the outdoor heat exchanger 7 and absorbs heat from the outside air to have a low temperature, and thus moisture in the outside air adheres to the outdoor heat exchanger 7 as frost.

Therefore, the heat pump controller 32 calculates a difference ΔTXO (=TXObase−TXO) between the outdoor heat exchanger temperature TXO (the refrigerant evaporating temperature at the outdoor heat exchanger 7) detected by the outdoor heat exchanger temperature sensor 49 and the refrigerant evaporating temperature TXObase at the time of no frosting at the outdoor heat exchanger 7. In the case in which the outdoor heat exchanger temperature TXO is lower than the refrigerant evaporating temperature TXObase at the time of no frosting and a state in which the difference ΔTXO is increased to a predetermined value or more is continued for a predetermined time, the heat pump controller determines that frosting has occurred at the outdoor heat exchanger 7 and sets a predetermined frosting flag.

When a charging plug is connected to the quick charger and the battery 55 is charged in a state in which the frost flag is set and the air conditioning switch of the air-conditioning operating unit 53 is turned off, the heat pump controller 32 executes the defrosting mode of the outdoor heat exchanger 7 as follows.

In the defrosting mode, the heat pump controller 32 brings the air-conditioning refrigerant circuit R into the heating mode, and then fully opens the valve opening of the outdoor expansion valve 6. The compressor 2 is then operated, the high-temperature refrigerant discharged from the compressor 2 flows into the outdoor heat exchanger 7 through the radiator 4 and the outdoor expansion valve 6, and the frost on the outdoor heat exchanger 7 is melted. In the case in which the outdoor heat exchanger temperature TXO detected by the outdoor heat exchanger temperature sensor 49 is higher than a predetermined defrosting end temperature (e.g., +3° C. or the like), the heat pump controller 32 determines that the defrosting of the outdoor heat exchanger 7 is completed, and ends the defrosting mode.

(10) Battery Heating Mode

When the air-conditioning operation is performed or when the battery 55 is charged, the heat pump controller 32 performs the battery heating mode. In this battery heating mode, the heat pump controller 32 operates the circulation pump 62 to energize the heat medium heater 63. Note that the electromagnetic valve 69 is closed.

As a result, the heat medium discharged from the circulation pump 62 reaches the heat medium flow path 64A of the refrigerant-heat medium heat exchanger 64 in the heat medium pipe 66, passes through the heat medium flow path 64A, and reaches the heat medium heater 63. At this time, since the heating medium heater 63 generates heat, the heating medium is heated by the heating medium heater 63 to rise in temperature, then reaches the battery 55, and exchanges heat with the battery 55. As a result, the battery 55 is heated, and the heating medium after heating the battery 55 repeats circulation in which the heating medium is sucked into the circulation pump 62.

In this battery heating mode, the heat pump controller 32 controls the energization of the heat medium heater 63 based on the heat medium temperature Tw detected by the heat medium temperature sensor 76 to adjust the heat medium temperature Tw to a predetermined target heat medium temperature TWO, and heat the battery 55.

(11) Control of Compressor 2 by Heat Pump Controller 32

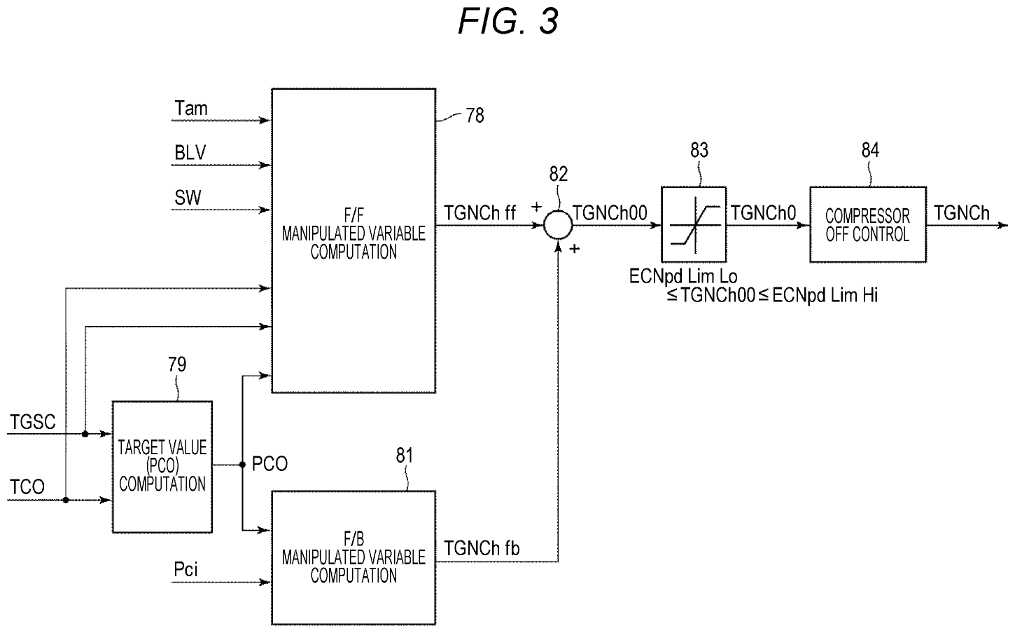

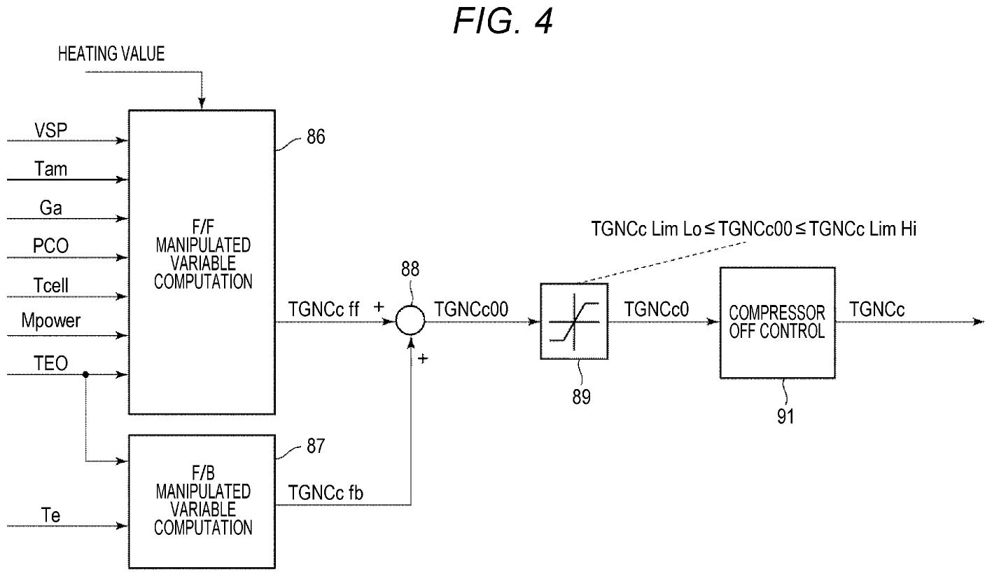

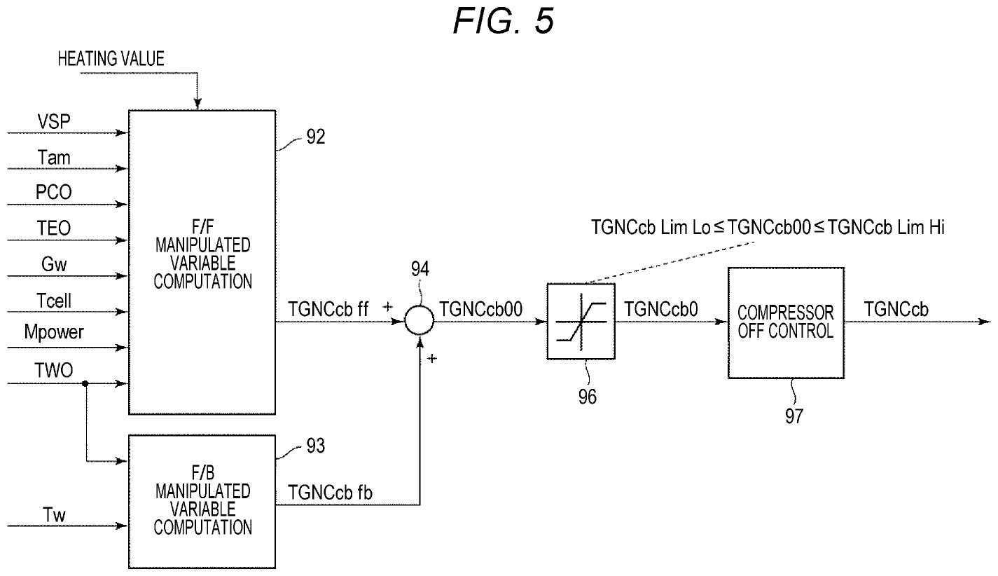

Furthermore, the heat pump controller 32 calculates a target revolution number (compressor target revolution number) TGNCh of the compressor 2 from the control block diagram of FIG. 3 based on the radiator pressure Pci in the heating mode, and calculates a target revolution number (compressor target revolution number) TGNCc of the compressor 2 from the control block diagram of FIG. 4 based on the heat absorber temperature Te in the dehumidifying cooling mode, the cooling mode, and the air conditioning (priority)+battery cooling mode. Note that in the dehumidifying and heating mode, a lower one of the compressor target revolution number TGNCh and the compressor target revolution number TGNCc is selected. Furthermore, in the battery cooling (priority)+air conditioning mode and the battery cooling (single) mode, a target revolution number (compressor target revolution number) TGNCCb of the compressor 2 is calculated by the control block diagram of FIG. 5 based on the heat medium temperature Tw.

(11-1) Calculation of Target Compressor Revolution Number TGNCh Based on Radiator Pressure Pci

First, the control of the compressor 2 based on the radiator pressure Pci will be described in detail with reference to FIG. 3. FIG. 3 is a control block diagram of the heat pump controller 32 that calculates a target revolution number (compressor target revolution number) TGNCh of the compressor 2 based on the radiator pressure Pci. An F/F (feedforward) manipulated variable computing unit 78 of the heat pump controller 32 calculates an F/F operation amount TGNChff of the compressor target revolution number based on the outside air temperature Tam obtained from the outside air temperature sensor 33, the blower voltage BLV of the indoor blower 27, the air volume ratio SW by the air mix damper 28 obtained by SW=(TAO−Te)/(Thp−Te), the target supercooling degree TGSC which is a target value of the supercooling degree SC of the refrigerant at the outlet of the radiator 4, the target heater temperature TCO, which is a target value of the heater temperature Thp, and the target radiator pressure PCO which is a target value of the pressure of the radiator 4.

Note that the heater temperature Thp is an air temperature (estimated value) on the leeward side of the radiator 4, and is calculated (estimated) from the radiator pressure Pci detected by the radiator pressure sensor 47 and the refrigerant outlet temperature Tci of the radiator 4 detected by the radiator outlet temperature sensor 44. Furthermore, the supercooling degree SC is calculated from the refrigerant inlet temperature Tcxin and the refrigerant outlet temperature Tci of the radiator 4 detected by the radiator inlet temperature sensor 43 and the radiator outlet temperature sensor 44.

The target radiator pressure PCO is calculated by the target value computing unit 79 based on the target supercooling degree TGSC and the target heater temperature TCO. Moreover, an F/B (feedback) manipulated variable computing unit 81 calculates an F/B operation amount TGNChfb of the compressor target revolution number by PID calculation or PI calculation based on the target radiator pressure PCO and the radiator pressure Pci. The F/F operation amount TGNChff calculated by the F/F manipulated variable computing unit 78 and the F/B operation amount TGNChfb calculated by the F/B manipulated variable computing unit 81 are then added by an adder 82 and input to a limit setting unit 83 as TGNCh00.

The limit setting unit 83 sets a lower limit revolution number ECNpdLimLo and the upper limit revolution number ECNpdLimHi for control to TGNCh0, and then determines the TGNCh0 as the compressor target revolution number TGNCh through a compressor OFF control unit 84. In the normal mode, the heat pump controller 32 controls the operation of the compressor 2 based on the compressor target revolution number TGNCh calculated based on the radiator pressure Pci.

Note that when the compressor target revolution number TGNCh becomes the above-described lower limit revolution number ECNpdLimLo and the state in which the radiator pressure Pci rises to the upper limit value PUL of the predetermined upper limit value PUL and the lower limit value PLL set above and below the target radiator pressure PCO is continued for a predetermined time th1, the compressor OFF control unit 84 enters an ON/OFF mode of stopping the compressor 2 and performing ON/OFF control of the compressor 2.

In the ON/OFF mode of the compressor 2, in the case in which the radiator pressure Pci decreases to the lower limit value PLL, the compressor 2 is started to operate the compressor target revolution number TGNCh as the lower limit revolution number ECNpdLimLo, and when the radiator pressure Pci increases to the upper limit value PUL in this state, the compressor 2 is stopped again. That is, the operation (ON) and the stop (OFF) of the compressor 2 at the lower limit engine speed ECNpdLimLo are repeated. In the case in which the state in which the radiator pressure Pci does not become higher than the lower limit value PUL continues for a predetermined time th2 after the radiator pressure Pci decreases to the lower limit value PUL and the compressor 2 is started, the ON/OFF mode of the compressor 2 is ended and the mode returns to the normal mode.

(11-2) Calculation of Target Compressor Revolution Number TGNCc Based on Heat Absorber Temperature Te

Next, control of the compressor 2 based on the heat absorber temperature Te will be described in detail with reference to FIG. 4. FIG. 4 is a control block diagram of the heat pump controller 32 that calculates a target revolution number (compressor target revolution number) TGNCc of the compressor 2 based on the heat absorber temperature Te. An F/F (feedforward) manipulated variable computing unit 86 of the heat pump controller 32 calculates an F/F operation amount TGNCcff of the compressor target revolution number based on the outside air temperature Tam, the air volume Ga of the air flowing through the air flow passage 3 (which may be the blower voltage BLV of the indoor blower 27), the target radiator pressure PCO, the battery temperature Tcell detected by the battery temperature sensor 77 (transmitted from the battery controller 73), the output Mpower of the traveling motor (transmitted from the vehicle controller 72), the vehicle speed VSP, the heating value of the battery 55 (transmitted from the battery controller 73), and the target heat absorber temperature TEO, which is a target value of the heat absorber temperature Te.

Furthermore, an F/B manipulated variable computing unit 87 calculates an F/B operation amount TGNCcfb of the compressor target revolution number by PID calculation or PI calculation based on the target heat absorber temperature TEO and the heat absorber temperature Te. The F/F operation amount TGNCcff calculated by the F/F manipulated variable computing unit 86 and the F/B operation amount TGNCcfb calculated by the F/B manipulated variable computing unit 87 are then added by an adder 88 and input to a limit setting unit 89 as TGNCc00.

The limit setting unit 89 sets a lower limit revolution number TGNCcLimLo and an upper limit revolution number TGNCcLimHi for control to TGNCc0, and then determines the target revolution number TGNCc through a compressor OFF control unit 91. In the normal mode, the heat pump controller 32 controls the operation of the compressor 2 based on the compressor target revolution number TGNCc calculated based on the heat absorber temperature Te.

Note that in the case in which the compressor target revolution number TGNCc becomes the above-described lower limit revolution number TGNCcLimLo and the state in which the heat absorber temperature Te decreases to the lower limit value TeLL of the upper limit value TeUL and the lower limit value TeLL set above and below the target heat absorber temperature TEO continues for a predetermined time tc1, the compressor OFF control unit 91 enters an ON/OFF mode of stopping the compressor 2 and performing ON/OFF control of the compressor 2.

In the ON/OFF mode of the compressor 2 in this case, when the heat absorber temperature Te rises to the upper limit value TeUL, the compressor 2 is started to operate the compressor target revolution number TGNCc as the lower limit revolution number TGNCcLimLo, and when the heat absorber temperature Te falls to the lower limit value TeLL in this state, the compressor 2 is stopped again. That is, the operation (ON) and the stop (OFF) of the compressor 2 at the lower limit revolution number TGNCcLimLo are repeated. In the case in which a state in which the heat absorber temperature Te does not become lower than the upper limit value TeUL continues for a predetermined time tc2 after the heat absorber temperature Te rises to the upper limit value TeUL and the compressor 2 is started, the ON/OFF mode of the compressor 2 in this case is ended, and the mode returns to the normal mode.

(11-3) Calculation of Compressor Target Revolution Number TGNCcb Based on Heat Medium Temperature Tw

Next, control of the compressor 2 based on the heat medium temperature Tw will be described in detail with reference to FIG. 5. FIG. 5 is a control block diagram of the heat pump controller 32 that calculates a target revolution number (compressor target revolution number) TGNCcb of the compressor 2 based on the heat medium temperature Tw. An F/F (feedforward) manipulated variable computing unit 92 of the heat pump controller 32 calculates an F/F operation amount TGNCcbff of the compressor target revolution number based on the outside air temperature Tam, the target radiator pressure PCO, the target heat absorber temperature TEO, a flow rate Gw of the heat medium in the heat medium circuit 61 (calculated from the output of the circulation pump 62), the battery temperature Tcell, the output Mpower of the traveling motor (transmitted from the vehicle controller 72), the vehicle speed VSP, the heating value of the battery 55 (transmitted from the battery controller 73), and the target heat medium temperature TWO which is a target value of the heat medium temperature Tw.

Furthermore, an F/B manipulated variable computing unit 93 calculates an F/B operation amount TGNCcbfb of the compressor target revolution number by PID calculation or PI calculation based on the target heat medium temperature TWO and the heat medium temperature Tw. Then, the F/F operation amount TGNCcbff calculated by the F/F manipulated variable computing unit 92 and the F/B operation amount TGNCcbfb calculated by the FB manipulated variable computing unit 93 are added by an adder 94 and input to a limit setting unit 96 as TGNCcb00.

The limit setting unit 96 sets a lower limit revolution number TGNCcbLimLo and an upper limit revolution number TGNCcbLimHi in control to be TGNCcb0, and then determines the target revolution number TGNCcb through a compressor OFF control unit 97. In the normal mode, the heat pump controller 32 controls the operation of the compressor 2 based on the compressor target revolution number TGNCcb calculated based on the heat medium temperature Tw.

Note that when the compressor target revolution number TGNCcb becomes the above-described lower limit revolution number TGNCcbLimLo and the state in which the heat medium temperature Tw decreases to the lower limit value TLL of the upper limit value TUL and the lower limit value TLL set above and below the target heat medium temperature TWO is continued for a predetermined time tcb1, the compressor OFF control unit 97 enters an ON/OFF mode of stopping the compressor 2 and performing ON/OFF control of the compressor 2.

In the ON/OFF mode of the compressor 2 in this case, in the case in which the heat medium temperature Tw increases to the upper limit value TUL, the compressor 2 is activated to operate at the compressor target revolution number TGNCCb as the lower limit revolution number TGNCcbLimLo, and in the case in which the heat medium temperature Tw decreases to the lower limit value TLL in this state, the compressor 2 is stopped again. That is, the operation (ON) and the stop (OFF) of the compressor 2 at the lower limit revolution number TGNCcbLimLo are repeated. In the case in which a state in which the heat medium temperature Tw does not become lower than the upper limit value TUL continues for a predetermined time tcb2 after the heat medium temperature Tw rises to the upper limit value TUL and the compressor 2 is started, the ON/OFF mode of the compressor 2 in this case is ended, and the mode returns to the normal mode.

(12) Increase Control of Number of Revolutions of Compressor by Heat Pump Controller 32 (Part 1)

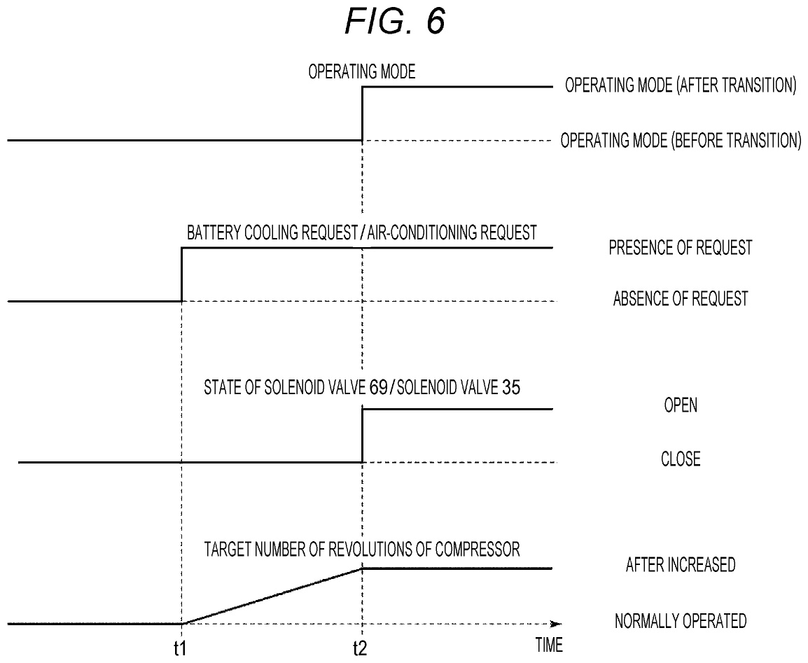

Next, an example of increase control of the number of revolutions of the compressor executed by the heat pump controller 32 when the cooling mode described above is transitioned to the air conditioning (priority)+battery cooling mode and when the battery cooling (single) mode is transitioned to the battery cooling (priority)+air conditioning mode will be described with reference to FIG. 6. Note that FIG. 6 collectively shows both of the above transitions.

Immediately after the transition from the cooling mode to the air conditioning (priority)+battery cooling mode described above, the number of heat exchange paths including the cooling mode and the air conditioning (priority)+battery cooling mode increases, and thus the capacity (number of revolutions) of the compressor 2 becomes insufficient, and the temperature of the air blown into the inside of the vehicle temporarily increases, which makes the user feel uncomfortable and delays the cooling of the battery 55.

Here, during the execution of the cooling mode, for example, in the case in which the heat medium temperature Tw detected by the heat medium temperature sensor 76 rises to the upper limit value TUL described above, or when the battery temperature Tcell detected by the battery temperature sensor 77 rises to a predetermined upper limit value, the battery controller 73 outputs a battery cooling request to the heat pump controller 32 or the air conditioning controller 45. For example, when a battery cooling request is input to the heat pump controller 32 at time t1 in FIG. 6, this becomes a mode transition request, and the heat pump controller 32 starts increase control of the number of revolutions of the compressor in this case, and first decreases the target heat absorber temperature TEO by a predetermined value TEO1.

As a result, since the F/F operation amount TGNCcff of the compressor target revolution number calculated by the F/F manipulated variable computing unit 86 in FIG. 4 increases, the finally calculated compressor target revolution number TGNCc also increases from the normal value, and the actual number of revolutions of the compressor 2 also increases. For example, in the case in which the compressor target revolution number TGNCc increases to the predetermined value TGNCc1 at time t2 in FIG. 6, or when a predetermined time ts1 elapses from time t1, the heat pump controller 32 opens the electromagnetic valve 69 and transitions the operating mode to the air conditioning (priority)+battery cooling mode.

By executing such increase control of the number of revolutions of the compressor, it is possible to eliminate the shortage of the capacity (number of revolutions) of the compressor 2 immediately after the transition from the cooling mode to the air conditioning (priority)+battery cooling mode, enhance the compatibility between the air conditioning of the inside of the vehicle and the cooling of the battery 55, and improve the reliability and the merchantability. Note that the control of the compressor 2 after the transition returns to the number of revolutions control in the air conditioning (priority)+battery cooling mode described above. As described above, since the electromagnetic valve 69 and the auxiliary expansion valve 68 are the expansion valve with an electromagnetic valve, the differential pressure when the electromagnetic valve 69 is opened in a state in which the number of revolutions of the compressor 2 increases is reduced, and noise is also suppressed.

Furthermore, since the capacity of the compressor 2 is insufficient even immediately after the transition from the battery cooling (single) mode to the battery cooling (priority)+air conditioning mode, the air conditioning in the inside of the vehicle is delayed and the cooling capacity of the battery 55 also temporarily decreases.

Here, in the case in which the air-conditioning switch of the air-conditioning operating part 53 is turned ON during the execution of the battery-cooling (single) mode, the air-conditioning controller 45 outputs an air-conditioning request to the heat pump controller 32. Similarly, in the case in which an air conditioning request is input to the heat pump controller 32 at time t1 in FIG. 6, this becomes a mode transition request, and the heat pump controller 32 starts increase control of the number of revolutions of the compressor in this case, and first decreases the target heat medium temperature TWO by a predetermined value TWO1.

As a result, since the F/F operation amount TGNCcbff of the compressor target revolution number calculated by the F/F manipulated variable computing unit 92 in FIG. 5 increases, the finally calculated compressor target revolution number TGNCcb also increases from the normal value, and the actual number of revolutions of the compressor 2 also increases. For example, in the case in which the compressor target revolution number TGNCcb increases to the predetermined value TGNCcb1 at time t2 in FIG. 6, the heat pump controller 32 opens the electromagnetic valve 35 and transitions the operating mode to the battery cooling (priority)+air conditioning mode.

By executing such an increase control of the number of revolutions of the compressor, it is possible to eliminate the shortage of the capacity (number of revolutions) of the compressor 2 immediately after the transition from the battery cooling (single) mode to the battery cooling (priority)+air conditioning mode, enhance the compatibility between the cooling of the battery 55 and the air conditioning in the inside of the vehicle, and improve the reliability and the merchantability. Note that the control of the compressor 2 after the transition returns to the number of revolutions control in the battery cooling (priority)+air conditioning mode described above. Furthermore, as described above, since the electromagnetic valve 35 and the indoor expansion valve 8 are the expansion valve with an electromagnetic valve, the differential pressure when the electromagnetic valve 35 is opened in a state in which the number of revolutions of the compressor 2 is increased is reduced, and noise is also suppressed.

Furthermore, here, the heat pump controller 32 evaporates the refrigerant in any one of the heat absorber 9 and the refrigerant-heat medium heat exchanger 64 in the cooling mode and the battery cooling (single) mode, and evaporates the refrigerant in the heat absorber 9 and the refrigerant-heat medium heat exchanger 64 in the air conditioning (priority)+battery cooling mode and the battery cooling (priority)+air conditioning mode. Therefore, it is possible to cool the battery 55 while cooling the inside of the vehicle in the cooling mode and the battery cooling (single) mode, and to cool the battery 55 while cooling the inside of the vehicle in the air conditioning (priority)+battery cooling mode and the battery cooling (priority)+air conditioning mode.

Since increase control of the number of revolutions of the compressor is executed at the time of transitioning from the cooling mode to the air conditioning (priority)+temperature control target cooling mode and at the time of transitioning from the battery cooling (single) mode to the battery cooling (priority)+air conditioning mode, it is possible to improve compatibility between air conditioning in the inside of the vehicle and the cooling of the battery 55 by avoiding an inconvenience beforehand that the temperature of the air blown into the inside of the vehicle increases immediately after transitioning from the cooling mode to the air conditioning (priority)+battery cooling mode and the user feels uncomfortable and an inconvenience that the cooling performance of the battery 55 decreases immediately after transitioning from the battery cooling (single) mode to the battery cooling (priority)+air conditioning mode.

In this case, the electromagnetic valve 35 that controls the flow of the refrigerant to the heat absorber 9 and the electromagnetic valve 69 that controls the flow of the refrigerant to the refrigerant-heat medium heat exchanger 64 are provided, and the heat pump controller 32 opens one of the electromagnetic valve 35 and the electromagnetic valve 69 and closes the other in the cooling mode and the battery cooling (single) mode, and opens the electromagnetic valve 35 and the electromagnetic valve 69 in the air conditioning (priority)+battery cooling mode and the battery cooling (priority)+air conditioning mode, and thus it is possible to smoothly execute each operating mode.

Moreover, here, the cooling mode in which the electromagnetic valve 35 is opened to control the number of revolutions of the compressor 2 at the heat absorber temperature Te and the electromagnetic valve 69 is closed, and the battery cooling (single) mode in which the electromagnetic valve 69 is opened to control the number of revolutions of the compressor 2 at the heat medium temperature Tw and the electromagnetic valve 35 is closed are executed, and thus it is possible to cool the inside of the vehicle and the battery 55 smoothly.

Furthermore, here, the air conditioning (priority)+battery cooling mode in which the electromagnetic valve 35 is opened, the number of revolutions of the compressor 2 is controlled at the heat absorber temperature Te, and the electromagnetic valve 69 is controlled to be opened and closed at the heat medium temperature Tw, and the battery cooling (priority)+air conditioning mode in which the electromagnetic valve 69 is opened, the number of revolutions of the compressor 2 is controlled at the heat medium temperature Tw, and the electromagnetic valve 35 is controlled to be opened and closed at the heat absorber temperature Te are executed. Furthermore, therefore, in performing cooling of the battery 55 while cooling the inside of the vehicle is performed, whether to prioritize the cooling of the inside of the vehicle or to prioritize the cooling of the battery 55 according to the situation is switched, and it is possible to achieve comfortable cooling of the inside of the vehicle interior cooling and effective cooling of the battery 55.

Furthermore, as in this example, by lowering the target heat absorber temperature TEO and the target heat medium temperature TWO input to the F/F manipulated variable computing units 86 and 92 by increase control of the number of revolutions of the compressor, the compressor target revolution numbers TGNCc and TGNCcb are increased, and thus it is possible to accurately increase the number of revolutions of the compressor 2 by increase control of the number of revolutions of the compressor in the cooling mode and the battery cooling (single) mode.

Moreover, as in this example, in the case in which a battery cooling request or an air conditioning request (both are mode transition requests) is input in the cooling mode or the battery cooling (single) mode, when the heat pump controller 32 makes a transition to the air conditioning (priority)+battery cooling mode or the battery cooling (priority)+air conditioning mode after increasing the number of revolutions of the compressor 2 by the increase control of the number of revolutions of the compressor, it is possible to reliably increase the number of revolutions of the compressor 2 prior to transitioning to the air conditioning (priority)+battery cooling mode or the battery cooling (priority)+air conditioning mode.

(13) Increase Control of Number of Revolutions of Compressor by Heat Pump Controller 32 (Part 2)

Next, another example of increase control of the number of revolutions of the compressor executed by the heat pump controller 32 when the cooling mode is transitioned to the air conditioning (priority)+battery cooling mode will be described. In the case in which the output Mpower of the motor for traveling increases in the cooling mode, the temperature of the battery 55 increases. Therefore, it is expected that the battery cooling request is issued after that and the mode transitions to the air conditioning (priority)+battery cooling mode.

Therefore, in the case in which the output Mpower of the traveling motor becomes equal to or greater than the predetermined threshold Mpower1, the heat pump controller 32 executes the above-described increase control of the number of revolutions of the compressor (lowering the target heat absorber temperature TEO). As a result, it is possible to increase the number of revolutions of the compressor 2 prior to transitioning to the air conditioning (priority)+battery cooling mode and to enhance compatibility between air conditioning in the inside of the vehicle immediately after the transition and the cooling of the battery 55. Specifically, in this case, since the number of revolutions of the compressor 2 can be increased before the battery cooling request is input, it is possible to transition to the air conditioning (priority)+battery cooling mode at an early stage.

(14) Increase Control of Number of Revolutions of Compressor by Heat Pump Controller 32 (Part 3)

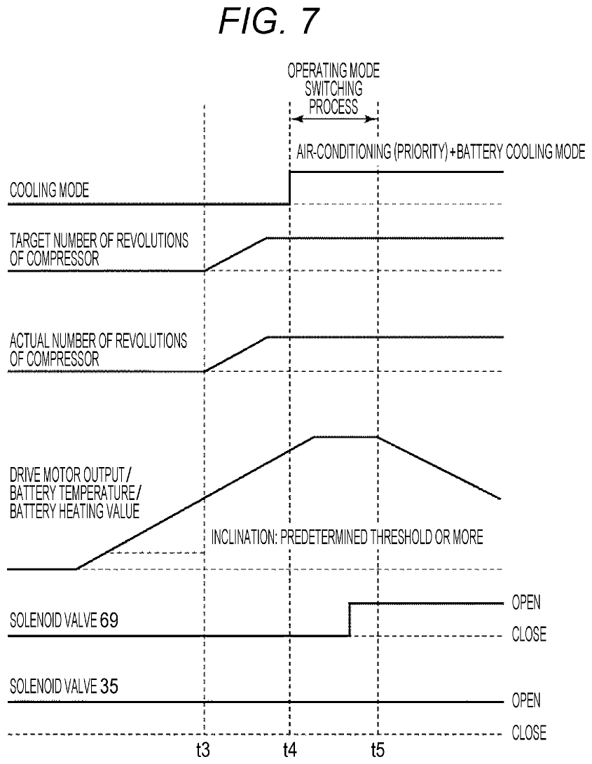

Next, another example of increase control of the number of revolutions of the compressor executed by the heat pump controller 32 at the time of transition from the cooling mode to the air conditioning (priority)+battery cooling mode described above will be described with reference to FIG. 7.

In the cooling mode, even when the output Mpower of the traveling motor rapidly increases, when the battery temperature Tcell rapidly increases, or when the heating value of the battery 55 rapidly increases, it is expected to transition to the air conditioning (priority)+battery cooling mode after that. For example, at time t3 in FIG. 7, in the case in which an inclination at which the output Mpower of the traveling motor increases is equal to or greater than a predetermined threshold X1, in the case in which an inclination indicated by the battery temperature Tcell is equal to or greater than a predetermined threshold X2, or in the case in which the heating value of the battery 55 is equal to or greater than a predetermined threshold X3, the heat pump controller 32 starts increase control of the number of revolutions of the compressor in this case, and first decreases the target heat absorber temperature TEO by the predetermined value TEO1. Note that the threshold values X1 to X3 are values obtained in advance by an experiment.

As a result, since the compressor target revolution number TGNCc increases in the same manner as described above, the actual number of revolutions (actual number of revolutions) of the compressor 2 also increases. The heat pump controller 32 increases the compressor target revolution number TGNCc to a predetermined value TGNCc1. After that, when a battery cooling request is input at time t4, the heat pump controller 32 transitions the mode to the air conditioning (priority)+battery cooling mode, and in this case, the operating mode switching process is performed until time t5. The electromagnetic valve 69 is then opened during the operating mode switching process.

With such increase control of the number of revolutions of the compressor, it is possible to eliminate the shortage of the capacity (number of revolutions) of the compressor 2 immediately after the transition from the cooling mode to the air conditioning (priority)+battery cooling mode, enhance the compatibility between the air conditioning of the inside of the vehicle and the cooling of the battery 55, and improve the reliability and the merchantability. Specifically, also in this case, since the number of revolutions of the compressor 2 can be increased before the battery cooling request is input, it is possible to transition the mode to the air conditioning (priority)+battery cooling mode at an early stage. Note that the control of the compressor 2 after the transition returns to the number of revolutions control in the air conditioning (priority)+battery cooling mode described above.

(15) Increase Control of Number of Revolutions of Compressor by Heat Pump Controller 32 (Part 4)

Furthermore, when the cooling mode is being executed, for example, even in the case in which high-speed traveling on an expressway is continued, it is expected that the temperature of the battery 55 increases after that and the mode transitions to the air conditioning (priority)+battery cooling mode. Accordingly, in the case in which navigation information obtained from GPS navigation device 74 in the cooling mode indicates, for example, that vehicle 1 travels on a highway in the future and the temperature of battery 55 is predicted to rise, the heat pump controller 32 executes the above-described increase control of the number of revolutions of the compressor (lowering target heat absorber temperature TEO).

As a result, the number of revolutions of the compressor 2 can be increased before the battery cooling request is input, and thus it is possible to transition the mode to the air conditioning (priority)+battery cooling mode at an early stage.

Note that the heat pump controller 32 executes increase control of the number of revolutions of the compressor of (13) to (15) instead of increase control of the number of revolutions of the compressor of (12) described above, and increase control of the number of revolutions of the compressor of (13) to (15) executes any one, a combination, or all of them.

(16) Suppression Control of Excess Cooling in Vehicle Compartment when Compressor Rotation Speed Rise Control is Executed

Here, when the number of revolutions of the compressor 2 is increased in the cooling mode, the temperature of the air blown into the inside of the vehicle decreases in a period before the transition to the air conditioning (priority)+battery cooling mode, that is, a period from time t1 to time t2 in FIG. 6 and a period from time t3 to time t4 in FIG. 7.

Therefore, in the case of executing increase control of the number of revolutions of the compressor at the time of transitioning from the cooling mode to the air conditioning (priority)+battery cooling mode, the heat pump controller 32 suppresses the operation of the indoor blower 27. That is, by reducing the number of revolutions of the indoor blower 27, an inconvenience that the inside of the vehicle is excessively cooled is eliminated.

(17) Control for Suppressing Decrease in Blow Temperature when Compressor Rotation Rise Control is Executed

Alternatively or in addition to the above, in the case in which increase control of the number of revolutions of the compressor is executed, the heat pump controller 32 may control the air mix damper 28 to increase the ratio of the air ventilated to the radiator 4. As a result, a decrease in the temperature of the air supplied into the cabin is suppressed, and thus it is possible to eliminate an inconvenience that the cabin is excessively cooled.

(18) Air Conditioning (Priority)+Open/Close Control of Branch Control Valve During Transition to Battery Cooling Mode

In the above description, it is described that, by executing increase control of the number of revolutions of the compressor at the time of transitioning from the cooling mode to the air conditioning (priority)+temperature control target cooling mode, the temperature of the air blown into the passenger compartment increases immediately after transitioning from the cooling mode to the air conditioning (priority)+battery cooling mode, and it is possible to eliminate the inconvenience that the user feels discomfort.

At this time, when the number of revolutions of the compressor to be controlled reaches the upper limit, the capacity of the compressor is insufficient against a situation in which the route of heat exchange through which the refrigerant flows increases at the time of transition from the cooling mode to the air conditioning (priority)+battery cooling mode, and the cooling capacity in the inside of the vehicle is temporarily lowered.

In order to solve this problem, the heat pump controller 32 opens and closes the electromagnetic valve 69 as the branch control valve 60 in accordance with the cooling capacity state of the air-conditioning refrigerant circuit R at the time of transition from the cooling mode to the air conditioning (priority)+battery cooling mode. Accordingly, immediately after the transition of the operating mode, it is possible to reduce the amount of the refrigerant flowing through the branch refrigerant circuit Rd, and it is possible to suppress a decrease in cooling capacity of the air-conditioning refrigerant circuit R.

At this time, the heat pump controller 32 adopts the heat absorber temperature Te detected by the heat absorber temperature sensor 48 or the blowout temperature detected by the blowout temperature sensor 41 as the detected temperature indicating the cooling capacity state of the air-conditioning refrigerant circuit R, performs control to set the detected temperature to a target value, and performs control to close the electromagnetic valve 69 when the detected temperature is higher than the target value or a set value lower than the target value, and perform control to open the electromagnetic valve 69 when the detected temperature is lower than the target value or the set value lower than the target value.

In the description of the control by the heat absorber temperature Te, the heat pump controller 32 controls opening and closing of the electromagnetic valve 69 based on the heat absorber temperature Te and the target heat absorber temperature TEO which is a target value thereof. In the following description, the same control can be performed when the blowing temperature is adopted instead of the heat absorber temperature Te. At this time, the heat pump controller 32 sets the upper limit value TeUL and the lower limit value TeLL with a predetermined temperature difference as setting values above and below the target heat absorber temperature TEO or lower than the target heat absorber temperature TEO, and closes the electromagnetic valve 69 when the heat absorber temperature Te increases to be equal to or higher than the upper limit value TeUL after opening the electromagnetic valve 69 in response to a battery cooling request. As a result, the refrigerant flowing into the branch refrigerant circuit Rd stops, and the cooling capacity of the air-conditioning refrigerant circuit R is restored. After that, when the heat absorber temperature Te decreases to the lower limit value TeLL or less, the electromagnetic valve 69 is opened to flow the refrigerant to the branch refrigerant circuit Rd. After that, such opening and closing of the electromagnetic valve 69 is repeated to control the heat absorber temperature Te to the target heat absorber temperature TEO, and thus a gradual transition is achieved from the cooling mode to the air conditioning (priority)+battery cooling mode while suppressing a temporary decrease in cooling capacity of indoor cooling.

The opening/closing control of the electromagnetic valve 69 that controls the heat absorber temperature Te to the target heat absorber temperature TEO (alternatively, the blowing temperature is controlled to a target value) can be combined with the opening/closing control of the electromagnetic valve 69 that controls the heat medium temperature Tw to the target heat medium temperature TWO in the above (5). At this time, the battery temperature Tcell detected by the battery temperature sensor 77 may be adopted instead of the heat medium temperature Tw, and may be combined with the opening/closing control of the electromagnetic valve 69 that controls the battery temperature Tcell to a target value.

That is, the heat pump controller 32 monitors the heat medium temperature Tw detected by the heat medium temperature sensor 76 or the battery temperature Tcell detected by the battery temperature sensor 77 at the time of transition from the cooling mode to the air conditioning (priority)+battery cooling mode, performs opening/closing control of the electromagnetic valve 69 that controls the heat absorber temperature Te to the target heat absorber temperature TEO in a state in which the heat medium temperature Tw or the battery temperature Tcell immediately after the transition is high, and switches to opening/closing control of the electromagnetic valve 69 that controls the heat medium temperature Tw or the battery temperature Tcell to a target value when the heat medium temperature Tw or the battery temperature Tcell becomes a low temperature state in which the heat medium temperature Tw or the battery temperature Tcell is set.

Even after such switching, the heat pump controller 32 sets the upper limit value TUL and the lower limit value TLL with a predetermined temperature difference as set values above and below the target heat medium temperature TWO or lower than the target heat absorber temperature TEO, opens the electromagnetic valve 69 when the heat medium temperature Tw is equal to or higher than the upper limit value TUL, and closes the electromagnetic valve 69 when the heat medium temperature Tw decreases to or lower than the lower limit value TLL. After that, such opening and closing of the electromagnetic valve 69 is repeated to control the heat medium temperature Tw to the target heat medium temperature TWO while prioritizing the cooling of the inside of the vehicle for cooling the battery 55.

Although the battery 55 as the heat generating device is cooled by the heat medium that exchanges heat with the branch refrigerant circuit Rd in this example, the battery 55 as the heat generating device may be directly cooled by the refrigerant of the branch refrigerant circuit Rd. In this case, the heat pump controller 32 monitors the refrigerant temperature or the battery temperature Tcell in the branch refrigerant circuit Rd at the time of transition from the cooling mode to the air conditioning (priority)+battery cooling mode, performs opening/closing control of the electromagnetic valve 69 that controls the heat absorber temperature Te to the target heat absorber temperature TEO in a state in which the refrigerant temperature or the battery temperature Tcell immediately after the transition is high, and switches to opening/closing control of the electromagnetic valve 69 that controls the refrigerant temperature or the battery temperature Tcell to a target value when the refrigerant temperature or the battery temperature Tcell becomes a set low temperature state.

(19) Combination Control of Opening/Closing Control of Branch Control Valve and Compressor Rotation Speed Rise Control

The opening/closing control of the branch control valve 60 (electromagnetic valve 69) described above in (18) can be combined with increase control of the number of revolutions of the compressor described above in (12) and the like.

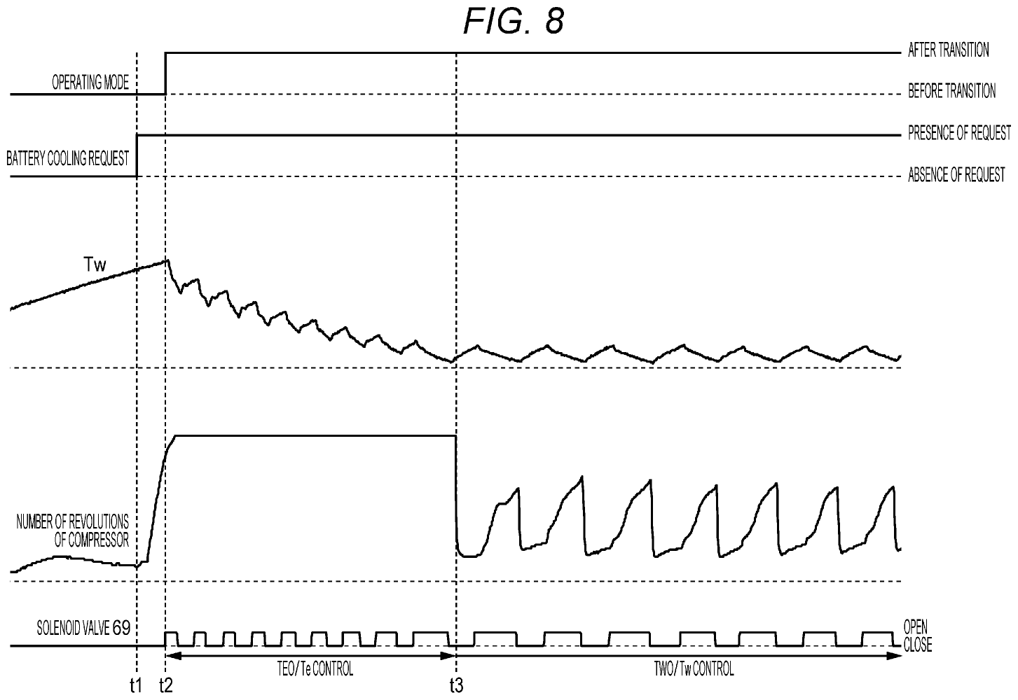

An example of increase control of the number of revolutions of the compressor and the opening/closing control of the branch control valve 60 executed by the heat pump controller 32 at the time of transition from the cooling mode to the air conditioning (priority)+battery cooling mode will be described with reference to FIG. 8.

In the case in which, for example, the heating medium temperature Tw detected by the heating medium temperature sensor 76 rises to the upper limit value TUL during the execution of the cooling mode, the battery controller 73 outputs a battery cooling request to the heat pump controller 32 and the air conditioning controller 45. In the case in which a battery cooling request is input to the heat pump controller 32 at time t1 in FIG. 8, this becomes a mode transition request, and the heat pump controller 32 starts increase control of the number of revolutions of the compressor in this case to increase the number of revolutions of the compressor 2 to a set number of revolutions. The set number of revolutions at this time is set in consideration of the cooling request capability of the battery 55 as a heat generating device.

As shown in FIG. 8, time t2 when the number of revolutions of the compressor 2 increases to the set number of revolutions is set as the time of transition of the operating mode, and the opening and closing control of the electromagnetic valve (branch control valve) 69 is started from time t2. Immediately after the transition of the operating mode, as described above, the opening and closing control of the electromagnetic valve 69 that controls the heat absorber temperature Te to the target heat absorber temperature TEO is performed, and when the heat medium temperature Tw becomes equal to or lower than the set value (time t3), switching to the opening and closing control of the electromagnetic valve 69 that controls the heat medium temperature Tw to the target value (target heat medium temperature TWO) is performed. At this time, the number of revolutions of the compressor 2 maintains the set rotation immediately after the transition of the operating mode, and when the heat medium temperature Tw becomes equal to or lower than the set value (time t3), the number of revolutions of the compressor 2 is also switched to the number of revolutions control that controls the heat medium temperature Tw to a target value (target heat medium temperature TWO).

As described above, by performing the number of revolutions increase control of the compressor 2 prior to the opening/closing control of the branch control valve 60 (the electromagnetic valve 69), it is possible to suppress the capacity (number of revolutions) shortage of the compressor 2 immediately after the transition from the cooling mode to the air conditioning (priority)+battery cooling mode, and it is possible to enhance the responsiveness when controlling the heat absorber temperature Te to the target heat absorber temperature TEO at the time of performing the opening/closing control of the branch control valve 60. As a result, it is possible to avoid beforehand the discomfort of the occupant caused by the decrease in the cooling capacity immediately after the transition from the cooling mode to the air conditioning (priority)+battery cooling mode.

(20) Notifying User when Transition from Cooling Mode to Air Conditioning (Priority)+Battery Cooling

The increase in the heat absorber temperature Te and the blowout temperature immediately after the transition from the cooling mode to the air conditioning (priority)+battery cooling mode can be suppressed by increase control of the number of revolutions of the compressor and the opening/closing control of the branch control valve 60 described above. However, when the blowout temperature slightly increases immediately after the transition from the cooling mode to the air conditioning (priority)+battery cooling mode, the occupant may misunderstand that there is a defect in the air conditioning. In order to solve this problem, prior to the transition from the cooling mode to the air conditioning (priority)+battery cooling mode, it is effective to notify that there is no failure even though the blowout temperature temporarily increases. Specifically, when the operation mode is transitioned, the heat pump controller 32 outputs a display for notifying that a temporary decrease in cooling capacity is predicted to display 53A.

Note that in the above description, the transition from the cooling mode to the air conditioning (priority)+battery cooling mode is described as an example of the transition to the operation in which the cooling of the inside of the vehicle by the air-conditioning refrigerant circuit and the cooling of the heat generating device by the branch refrigerant circuit are performed in parallel. However, similar control can be adopted also when the transition from the battery cooling (single) mode to the air conditioning (priority)+battery cooling mode is performed.

Although the embodiments of the present invention have been described in detail above, the specific configuration is not limited to these embodiments, and modifications and the like of the design without departing from the gist of the present invention are also included in the present invention. Furthermore, each of the above-described embodiments can be combined by diverting their techniques as long as there is no particular contradiction or problem in the purpose, configuration, and the like.

### LIST OF REFERENCE SIGNS

1 Vehicle air-conditioning apparatus
2 Compressor
3 Air flow passage
4 Radiator
6 Outdoor expansion valve
7 Outdoor heat exchanger
8 Indoor expansion valve
9 Heat absorber (evaporator)
11 Control unit
32 Heat pump controller (constituting part of control unit)
35 Electromagnetic valve (heat absorber valve device)
45 Air-conditioning controller (constituting part of control unit)
55 Battery (temperature control target)
60 Branch control valve
61 Heat medium circuit
64 Refrigerant-heat medium heat exchanger (evaporator and temperature control target heat exchanger)
68 Auxiliary expansion valve
69 Electromagnetic valve
72 Vehicle controller
73 Battery controller
77 Battery temperature sensor
76 Heat medium temperature sensor
R Air-conditioning refrigerant circuit
Rd Branch refrigerant circuit

What is claimed is:

1. A vehicle air-conditioning apparatus comprising:
an air-conditioning refrigerant circuit that circulates a refrigerant to cool an inside of the vehicle;
a branch refrigerant circuit that branches from the air-conditioning refrigerant circuit and cools a heat generating device;
a branch control valve that is provided in the branch refrigerant circuit and controls circulation of a refrigerant flowing into the branch refrigerant circuit from the air-conditioning refrigerant circuit; and
a control unit that controls an operation of the air-conditioning refrigerant circuit and the branch control valve, wherein
after transition to an operation of cooling the inside of the vehicle by the air-conditioning refrigerant circuit and cooling the heat generating device by the branch refrigerant circuit in parallel,
the control unit controls the branch control valve to be opened and closed according to a cooling capacity state of the air-conditioning refrigerant circuit.

2. The vehicle air-conditioning apparatus according to claim 1, wherein
the control unit performs control to set a detected temperature indicating a cooling capacity state of the air-conditioning refrigerant circuit to a target value, and
the branch control valve is closed when the detected temperature is higher than the target value or higher than a set value lower than the target value, and the branch control valve is opened when the detected temperature is lower than the target value or lower than the set value lower than the target value.

3. The vehicle air-conditioning apparatus according to claim 2, wherein the detected temperature is a heat absorber temperature or a blowout temperature in the air-conditioning refrigerant circuit.

4. The vehicle air-conditioning apparatus according to claim 2, wherein
to the set value, an upper limit value and a lower limit value having a predetermined temperature difference are set, and
the control unit closes the branch control valve when the detected temperature rises to the upper limit value or more, and opens the branch control valve when the detected temperature falls to the lower limit value or less.

5. The vehicle air-conditioning apparatus according to claim 1, wherein
before starting opening and closing control of the branch control valve,
the control unit increases the compressor in the air-conditioning refrigerant circuit to a set number of revolutions.

6. The vehicle air-conditioning apparatus according to claim 5, wherein the set number of revolutions is set in consideration of a cooling request capability of the heat generation device.

7. The vehicle air-conditioning apparatus according to claim 1, wherein the heat generating device is cooled by the branch refrigerant circuit by direct cooling using a refrigerant.

8. The vehicle air-conditioning apparatus according to claim 1, wherein the heat generating device is cooled by the branch refrigerant circuit by a heat medium that exchanges heat with the branch refrigerant circuit.

9. The vehicle air-conditioning apparatus according to claim 7, wherein
the control unit monitors a refrigerant temperature of the branch refrigerant circuit or a temperature of the heat generating device, and
when the refrigerant temperature or the temperature of the heat generating device becomes a set low temperature state, the on-off control of the branching control valve is switched from control according to a cooling capacity state of the air-conditioning refrigerant circuit to control for setting the refrigerant temperature or the temperature of the heat generating device to a target value.

10. The vehicle air-conditioning apparatus according to claim 8, wherein
the control unit monitors a heating medium temperature of a heating medium that exchanges heat with the branch refrigerant circuit or a temperature of the heat generating device, and when the heating medium temperature or the temperature of the heat generating device becomes a set low temperature state, and
opening and closing control of the branch control valve is switched from control according to a cooling capacity state of the air-conditioning refrigerant circuit to control for setting the heat medium temperature or the temperature of the heat generating device to a target value.

11. The vehicle air-conditioning apparatus according to claim 1, wherein
when performing an operation of cooling the inside of the vehicle by the air-conditioning refrigerant circuit and cooling the heat generating device by the branch refrigerant circuit in parallel,
the control unit notifies that a temporary decrease in cooling capacity is predicted.
